(19) United States
(12) Patent Application Publication
(10) Pub. No.: US 2026/0152007 A1
(43) Pub. Date: Jun. 4, 2026

(54) PRINTING APPARATUS, AND NON-TRANSITORY COMPUTER-READABLE STORAGE MEDIUM

(71) Applicant: CANON KABUSHIKI KAISHA, Tokyo (JP)

(72) Inventors: NORIBUMI KOITABASHI, Kanagawa (JP); YOSHIKAZU SAITO, Tokyo (JP); KENTARO MURO, Tokyo (JP)

(21) Appl. No.: 19/399,765

(22) Filed: Nov. 25, 2025

(30) Foreign Application Priority Data
Nov. 29, 2024 (JP) 2024-208882

(51) Int. Cl. B41J 2/195; B41J 2/045

(52) U.S. Cl. CPC B41J 2/195; B41J 2/04541; B41J 2/04563

(57) ABSTRACT

A printing apparatus including a printhead configured to execute printing by discharging ink, a tank configured to store ink to be supplied to the printhead, and a pump arranged in a circulation channel of ink passing through the tank and the printhead, the apparatus further comprising a measurement unit configured to measure, as a circulation flow rate, a flow rate of the ink that circulates in the circulation channel by the pump; and a specifying unit configured to specify quality of the ink in the circulation channel based on the circulation flow rate measured by the measurement unit.

### BACKGROUND

### Field of the Technology

The present disclosure mainly relates to a printing apparatus such as an inkjet printer.

### Description of the Related Art

Some printing apparatuses represented by an inkjet printer and the like are configured to circulate ink supplied to a printhead (see Japanese Patent Laid-Open No. 2018-8513).

In such printing apparatus, since it is considered that an ink concentration increases due to evaporation of the circulated ink from an ink discharge portion of the printhead, a technique for appropriately maintaining the ink concentration is generally required.

### SUMMARY

The present disclosure provides a technique advantageous in appropriately maintaining an ink concentration.

One of the aspects of the present disclosure provides a printing apparatus including a printhead configured to execute printing by discharging ink, a tank configured to store ink to be supplied to the printhead, and a pump arranged in a circulation channel of ink passing through the tank and the printhead, the apparatus further comprising a measurement unit configured to measure, as a circulation flow rate, a flow rate of the ink that circulates in the circulation channel by the pump; and a specifying unit configured to specify quality of the ink in the circulation channel based on the circulation flow rate measured by the measurement unit.

Features of the present disclosure will become apparent from the following description of embodiments with reference to the attached drawings. The following description of embodiments is given by way of example.

### BRIEF DESCRIPTION OF THE DRAWINGS

FIG. 1 is a perspective view of the main part of a printing apparatus according to an embodiment;

FIG. 2 is a block diagram of a control system of the printing apparatus;

FIG. 3 is a schematic view showing an ink circulation system in the printing apparatus;

FIGS. 4A and 4B are schematic views for explaining the inflow of ink to a printhead;

FIG. 5 is a perspective view of the printhead;

FIG. 6 is an exploded perspective view of the printhead;

FIGS. 7A, 7B, 7C, 7D, 7E, and 7F are schematic views of channel members;

FIG. 8 is a partially enlarged schematic view of the channel members;

FIG. 9 is a schematic sectional view of the channel members;

FIGS. 10A and 10B are perspective views of a discharge module;

FIGS. 11A, 11B, and 11C are schematic views of a printing element board;

FIG. 12 is a sectional perspective view of the printing element board;

FIG. 13 is an enlarged schematic view of a boundary portion between discharge modules;

FIGS. 14A, 14B, and 14C are views showing the configuration of the printing element board;

FIG. 15 is a schematic view showing an example of a configuration for detecting the amount of ink in a buffer tank;

FIG. 16 is a schematic view showing an example of a configuration for detecting the amount of ink in the buffer tank;

FIG. 17 is a schematic view showing an example of a configuration for detecting the amount of ink in the buffer tank;

FIG. 18 is a graph showing the relationship between a circulation flow rate and an ink viscosity;

FIG. 19 is a graph showing the relationship between the liquid level in the buffer tank and the circulation flow rate;

FIG. 20 is a graph showing the relationship between the degree of ink evaporation and the ink viscosity;

FIG. 21 is a graph showing the relationship between the degree of ink evaporation and the circulation flow rate;

FIG. 22 is a timing chart showing the temporal transition of the absorbance (corresponding to the ink concentration) of white ink;

FIG. 23 is a timing chart showing the temporal transition of the circulation flow rate;

FIG. 24 is a flowchart illustrating control contents based on the quality of ink in a circulation channel;

FIG. 25 is a graph showing the relationship between the ink viscosity and an ink temperature;

FIG. 26 is a graph showing the relationship between driving duty and a circulation flow rate;

FIG. 27 is a graph showing the relationship between the driving duty and an ink viscosity at a given circulation flow rate;

FIG. 28 is a graph showing the relationship between the ink viscosity and the ratio of the driving duty to a given circulation flow rate;

FIG. 29 is a flowchart illustrating contents of operation processing at the time of receiving a print job;

FIG. 30 is a flowchart illustrating contents of operation processing for calculating an evaporation amount;

FIG. 31 is a flowchart illustrating contents of operation processing for calculating an evaporation amount;

FIG. 32 is a flowchart illustrating contents of operation processing for calculating a consumed ink amount;

FIG. 33 is a flowchart illustrating contents of operation processing for calculating the ink concentration; and

FIG. 34 is a schematic view showing a practical example of the ink circulation system in the printing apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### (Overall Configuration of Printing Apparatus)

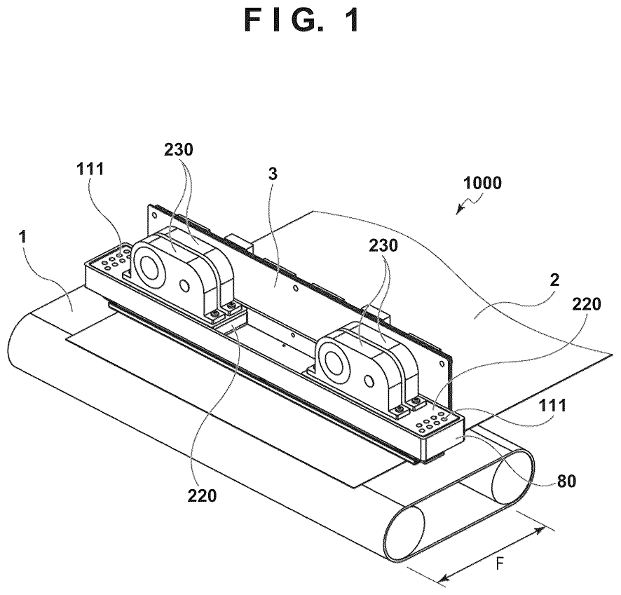

FIG. 1 is a perspective view showing the main part of a printing apparatus 1000 according to the first embodiment. In this embodiment, the printing apparatus 1000 is an inkjet printer that prints by discharging ink, and includes a conveyance unit 1 and a printhead 3. The conveyance unit 1 is configured to convey a print medium 2 such as a paper material (for example, a cut sheet or a roll sheet) in one direction, and includes, for example, a roller and a motor.

In this embodiment, the printhead 3 is a line head extending in the whole region in the widthwise direction of the print medium 2 (a direction intersecting/substantially orthogonal to the conveyance direction of the print medium 2 by the conveyance unit 1), and prints on the print medium 2 conveyed by the conveyance unit 1. As another embodiment, the printhead 3 may be a serial head that prints while reciprocally moving in the widthwise direction of the print medium 2.

Printing here indicates forming an image by discharging ink onto the print medium 2, and the concept of an image includes a character, a number, a symbol, a graphic, and a photograph regardless of whether the image is visible. The ink is typically a liquid containing dye or pigment, but may be a colorless and transparent reaction liquid or treatment liquid or may be expressed as a liquid including them. From this viewpoint, the printing apparatus 1000 may be expressed as a liquid discharge apparatus. Similarly, the printhead 3 may be expressed as a liquid discharge head. Note that the printing apparatus 1000 may be a copying machine having a print function as a main function and further having, as sub-functions, a copy function, a scanner function, and a facsimile function.

The printhead 3 includes a pressure control unit 230, a supply unit 220, a connection portion 111, and a housing 80 accommodating them or to which they are attached. The pressure control unit 230 is configured to control, to a negative pressure, a pressure in an ink channel as a channel which ink passes through. The supply unit 220 is connected to the pressure control unit 230 to communicate (fluidly communicate) with it. The connection portion 111 is configured to implement the inflow of the ink to the supply unit 220 and the outflow of the ink from the supply unit 220.

The printhead 3 can print by full-color printing using inks of a plurality of colors (in this example, four colors of cyan (C), magenta (M), yellow (Y), and black (K)), and is connected to a main tank 1006 (see FIG. 3) (to be described later) via a predetermined ink channel. In addition, the printhead 3 is connected to an electric control unit that is provided with a power supply voltage and a signal for discharging the ink.

Although details of the structure will be described later, the printing apparatus 1000 is configured to circulate the ink supplied to the printhead 3 in the apparatus (with a predetermined tank, details of which will be described later).

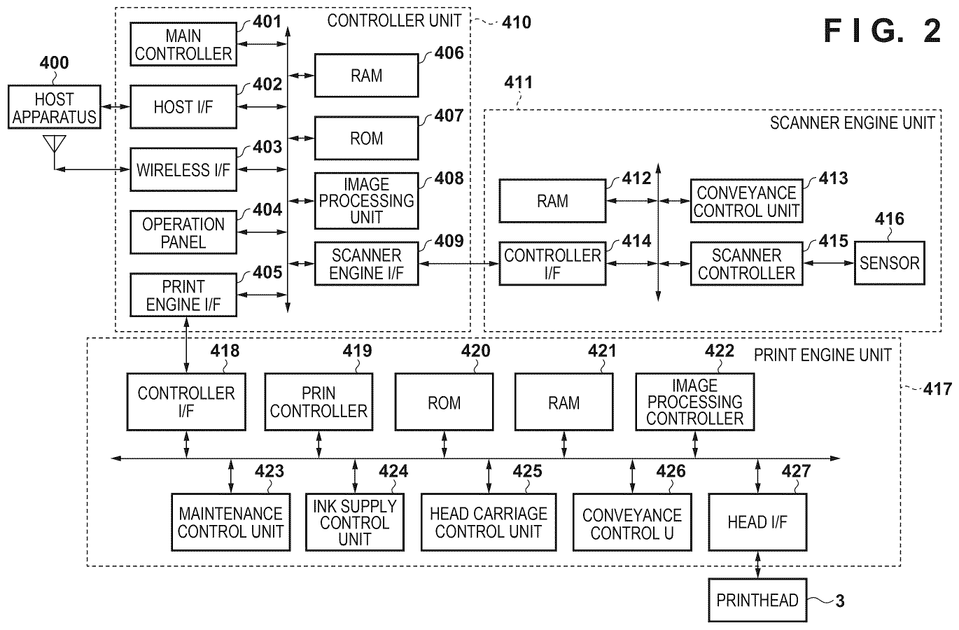

FIG. 2 is a block diagram showing an example of the configuration of a control system of the printing apparatus 1000. The printing apparatus 1000 includes, for example, a print engine unit 417 that comprehensively controls the print function, a scanner engine unit 411 that comprehensively controls the scanner function, and a controller unit 410 that comprehensively controls driving of the overall printing apparatus 1000.

The print engine unit 417 includes a print controller 419, a Read-Only Memory (ROM) 420, a Random Access Memory (RAM) 421, a controller interface (I/F) 418, an image processing controller 422, a head I/F 427, a conveyance control unit 426, a head carriage control unit 425, an ink supply control unit 424, and a maintenance control unit 423.

The scanner engine unit 411 includes a scanner controller 415, a controller I/F 414, a conveyance control unit 413, a sensor 416, and a RAM 412.

The controller unit 410 includes a main controller 401, a ROM 407, a RAM 406, a host I/F 402, a wireless I/F 403, an image processing unit 408, a print engine I/F 405, an operation panel 404, and a scanner engine I/F 409.

The print controller 419 incorporates a Micro Processing Unit (MPU) and a nonvolatile memory (for example, an EEPROM or the like), and controls various kinds of mechanisms of the print engine unit 417 in accordance with instructions from the main controller 401 of the controller unit 410. Various kinds of mechanisms of the scanner engine unit 411 are controlled by the main controller 401 of the controller unit 410.

In the controller unit 410, the main controller 401 implemented using a CPU controls the overall printing apparatus 1000 in accordance with programs and various kinds of parameters stored in the ROM 407 while using the RAM 406 as a work area. For example, a print job is input from a host apparatus 400 via the host I/F 402 or the wireless I/F 403. In accordance with this, the image processing unit 408 performs, in accordance with an instruction from the main controller 401, predetermined image processing on image data included in the print job or input together with the print job. Then, the main controller 401 transmits the image data having undergone the image processing to the print engine unit 417 via the print engine I/F 405.

The printing apparatus 1000 may obtain image data from the host apparatus 400 via wireless communication or wired communication, or may obtain image data from an external storage device (USB memory or the like) connected to the printing apparatus 1000. The communication method used for the wireless communication or wired communication is not limited. For example, Wi-Fi (Wireless Fidelity)® or Bluetooth® is applicable as the communication method used for the wireless communication. Universal Serial Bus (USB) or the like is applicable as the communication method used for the wired communication. For example, if a reading instruction is input from the host apparatus 400, the main controller 401 transmits the instruction to the scanner engine unit 411 via the scanner engine I/F 409.

The operation panel 404 can accept a user operation input to the printing apparatus 1000 and display information to the user. Thus, via the operation panel 404, the user can instruct an operation such as a copy operation or a scan operation, set a printing mode, or recognize information of the printing apparatus 1000.

In the print engine unit 417, the print controller 419 implemented using a CPU controls various kinds of mechanisms of the print engine unit 417 in accordance with programs and various kinds of parameters stored in the ROM 420 while using the RAM 421 as a work area.

When various kinds of commands and image data are received via the controller I/F 418, the print controller 419 temporarily stores them in the RAM 421. The print controller 419 causes the image processing controller 422 to convert the above-described stored image data into print data such that the printhead 3 can use it for a printing operation. When the print data is generated, the print controller 419 causes, via the head I/F 427, the printhead 3 to perform a printing operation based on the print data. At this time, the print controller 419 drives each conveyance unit (to be described later) via the conveyance control unit 426 to convey the print medium 2. When the printhead 3 performs the printing operation in synchronization with the conveyance operation in accordance with an instruction from the print controller 419, print processing is performed on the print medium 2.

The head carriage control unit 425 changes the orientation and position of the printhead 3 in accordance with the operation state of the printing apparatus 1000 such as a maintenance state or a printing state. The ink supply control unit 424 controls the supply unit 220 such that the pressure of the ink supplied to the printhead 3 falls within an appropriate range. The maintenance control unit 423 controls operations of a cap unit and a wiping unit in a maintenance unit (not shown) upon performing a maintenance operation of the printhead 3.

In the scanner engine unit 411, the main controller 401 controls the hardware resource of the scanner controller 415 in accordance with programs and various kinds of parameters stored in the ROM 407 while using the RAM 406 as a work area. With this operation, various kinds of mechanisms included in the scanner engine unit 411 are controlled. For example, the main controller 401 controls, via the controller I/F 414, the hardware resource in the scanner controller 415 to cause the conveyance control unit 413 to convey a document stacked on an Auto Document Feeder (ADF) (not shown) by a user, and read the document by the sensor 416. Then, the scanner controller 415 stores the read image data in the RAM 412.

Note that by converting the image data obtained as described above into print data, the print controller 419 can cause the printhead 3 to perform a printing operation based on the image data read by the scanner controller 415.

### (Ink Circulation System)

As shown in FIG. 3, the printing apparatus 1000 is configured to circulate the ink supplied to the printhead 3 in the apparatus. For the sake of descriptive simplicity, an ink channel for one of a plurality of colors is shown, but the same configuration is adopted for the remaining colors. In this embodiment, the printing apparatus 1000 further includes pumps 1001, 1002, and 1004, a tank 1003, the tank 1006, and sensors 1009a, 1009b, and 1009c.

The tank 1006 is attached to the apparatus main body to be able to store unused ink, and is expressed as the main tank 1006 to be distinguished from the tank 1003. The tank 1003 is incorporated in the apparatus to be able to store ink for circulation, and is expressed as the buffer tank 1003 to be distinguished from the tank 1006. The liquid amount sensor 1009a is configured to detect the ink amount in the buffer tank 1003. For example, a liquid level sensor that detects the liquid level in the buffer tank 1003 can be used.

The pump 1001 is configured to supply the ink in the main tank 1006 to the buffer tank 1003. The pump 1001 may be expressed as the liquid supply pump 1001 to be distinguished from the pumps 1002 and 1004.

The pumps 1002 and 1004 are arranged in the circulation channel of the ink passing through the printhead 3 and the buffer tank 1003, and the ink in the buffer tank 1003 can return to the buffer tank 1003 after being supplied to the printhead 3, that is, the ink can be circulated. In this embodiment, the pump 1004 can send the ink in the buffer tank 1003 to the printhead 3, and the pump 1002 can return the ink supplied to the printhead 3 to the buffer tank 1003, thereby making it possible to circulate the ink. The pump 1002 is arranged on the downstream side of the printhead 3 in the ink circulation direction, and may be expressed as the downstream-side circulation pump 1002 to be distinguished from the pump 1004. The pump 1004 is arranged on the upstream side of the printhead 3 in the ink circulation direction, and may be expressed as the upstream-side circulation pump 1004 to be distinguished from the pump 1002.

The ink thus supplied to the printhead 3 flows into the supply unit 220 via the connection portion 111 on one side, is adjusted to two different pressures (both are negative pressures) by the pressure control unit 230 after passing through a filter 221, and is branched into two ink channels on the high-pressure side and the low-pressure side to be supplied to a discharge unit 300.

Although details will be described later, the discharge unit 300 includes a common supply channel 211 and a common recovery channel 212. The ink on the high-pressure side is supplied to the common supply channel 211, and the ink on the low-pressure side is supplied to the common recovery channel 212. A plurality of individual channels 215 respectively corresponding to a plurality of printing element boards 10 are formed between the common supply channel 211 and the common recovery channel 212. For each individual channel 215, a channel on the upstream side of the corresponding printing element board 10 is an individual supply channel 213 and a channel on the downstream side of the corresponding printing element board 10 is an individual recovery channel 214. With this configuration, the ink can be supplied to each printing element board 10 by flowing from the common supply channel 211 to the common recovery channel 212 through the individual channel 215.

The ink that passes through the discharge unit 300 without being discharged by the discharge unit 300 is ejected by the pump 1002 from the printhead 3 via the connection portion 111 on the other side to return to the buffer tank 1003. The ink can be circulated in this way.

As the pump 1002, a positive-displacement pump that can pump the ink at a desired flow rate is used. In this embodiment, a diaphragm pump is used, but other known pumps such as a tube pump, a gear pump, and a syringe pump may be used. The amount of ink pumped by the pump 1002 corresponds to the flow rate (circulation flow rate) of the ink circulating in the circulation channel, and can be adjusted based on the driving force of the pump 1002. For example, in this embodiment in which a diaphragm pump is used as the pump 1002, the circulation flow rate is decided by adjusting the duty ratio of the driving signal of the pump 1002.

Furthermore, the flow rate sensor 1009b is arranged in the ink channel from the printhead 3 to the buffer tank 1003, and can measure the circulation flow rate. Note that the circulation flow rate is an amount of ink that passes through the ink channel per unit time, and can be measured in, for example, units of [milliliters/minute (ml/min)].

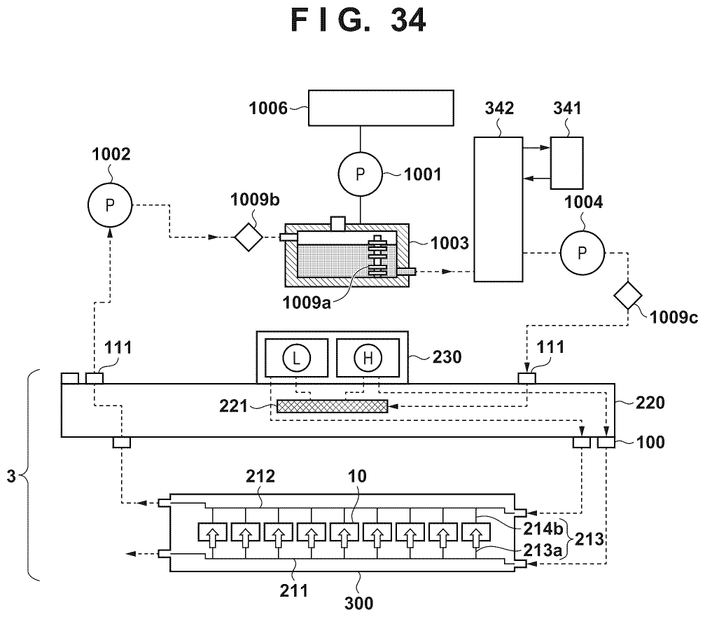

The printing apparatus 1000 is preferably installed and managed under a constant temperature environment. Alternatively, in addition to the temperature sensor 1009c, a chiller 341 and a heat exchanger 342 (see FIG. 34) may be arranged in the ink channel from the buffer tank 1003 to the printhead 3. Thus, it is possible to supply ink of a desired temperature (for example, 25° C.) to the printhead 3, that is, it is possible to maintain the printhead 3 at the desired temperature at the time of executing printing (driving the printhead 3). The ink flow rate at the time of executing printing is preferably set within the strength range of a member forming the ink channel so that the temperature difference between the plurality of printing element boards 10 falls within an allowable range (for example, the quality of an image is higher than a standard).

The pressure control unit 230 is arranged in the ink channel from the pump 1004 to the discharge unit 300, and can suppress or prevent variations of the pressure along with discharge of the ink for printing on the downstream side (that is, the side of the discharge unit 300) and maintain the pressure constant. The pressure control unit 230 includes two known pressure adjustment mechanisms (represented by “H” on the high-pressure side and “L” on the low-pressure side in FIG. 3) that generate two negative pressures, respectively, and for example, a pressure reducing regulator or a component equivalent to it is adopted.

In this embodiment, the pump 1004 pressurizes the ink channel on the upstream side of the pressure control unit 230 via the supply unit 220. This suppresses the influence of the water head pressure of the buffer tank 1003 on the printhead 3, and is advantageous in, for example, simplifying the design of the buffer tank 1003 such as the layout of the buffer tank 1003 in the printing apparatus 1000.

As the pump 1004, a pump having a standard pump head pressure or more is used. In this embodiment, a diaphragm pump is used, but another positive-displacement pump or turbo pump may be used.

With this configuration, the ink is supplied to pass through the common supply channel 211 and the common recovery channel 212 in the discharge unit 300, and a part of the ink passes through each printing element board 10. At this time, heat generated by each printing element board 10 is dissipated outside the printing element board 10 by the ink passing through the common supply channel 211 and the common recovery channel 212.

In addition, with this configuration, at the time of executing printing, it is possible to cause the ink to flow in a portion where the ink is not discharged in addition to portions (orifices 13 and a pressure chamber 23 to be described later (see FIG. 12 and the like)) where the ink is discharged. This can suppress an increase in viscosity of the ink in the circulation channel or suppress residence of the ink (thickened ink) whose viscosity increases, thereby improving the quality of printing by the printhead 3.

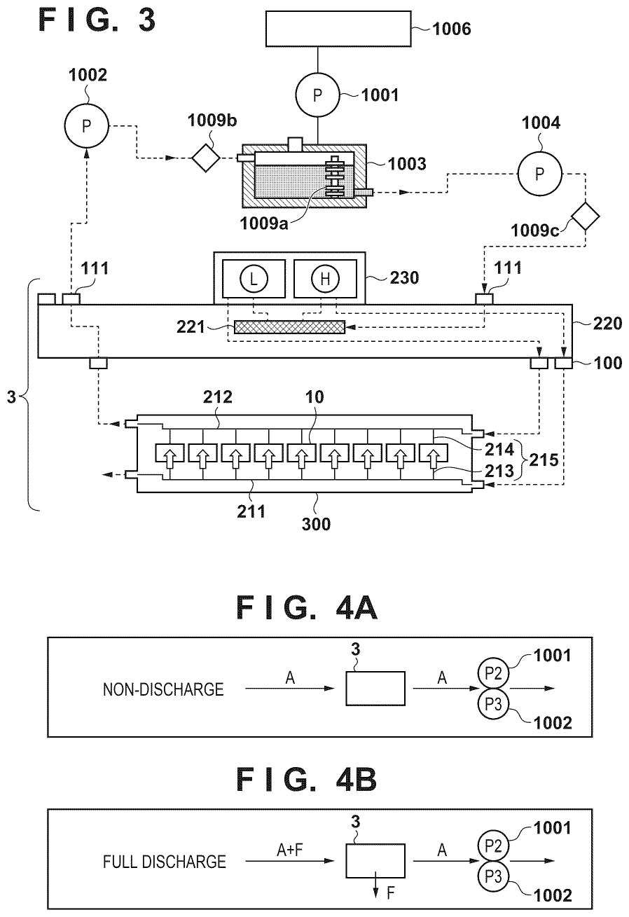

FIGS. 4A and 4B are schematic views for explaining the inflow of the ink to the printhead 3. FIG. 4A shows the ink flow rate in a case of non-discharge during ink circulation (in a case where the ink is not discharged from any orifice 13), and FIG. 4B shows the ink flow rate in a case of full discharge (in a case where the ink is discharged from all the orifices 13).

In this example, as described above, a flow rate A of the ink in the common supply channel 211 and the common recovery channel 212 in the case of non-discharge can be set such that the temperature difference between the plurality of printing element boards 10 falls within the allowable range. A discharge amount F in the case of full discharge is decided by multiplication of the amount of ink discharged from one orifice 13, the number of orifices 13 that discharge the ink, and the number of discharges per unit time (frequency).

Therefore, the flow rate A of the ink flowing out from printhead 3 is maintained at a predetermined value (value A) regardless of non-discharge or full discharge. On the other hand, the amount of ink flowing into the printhead 3 changes depending on the number of orifices 13 that discharge the ink (within the range of A (inclusive) to A+F (inclusive)). For example, the amount of ink is A in the case of non-discharge, and is A+F in the case of full discharge.

### (Configuration of Printhead)

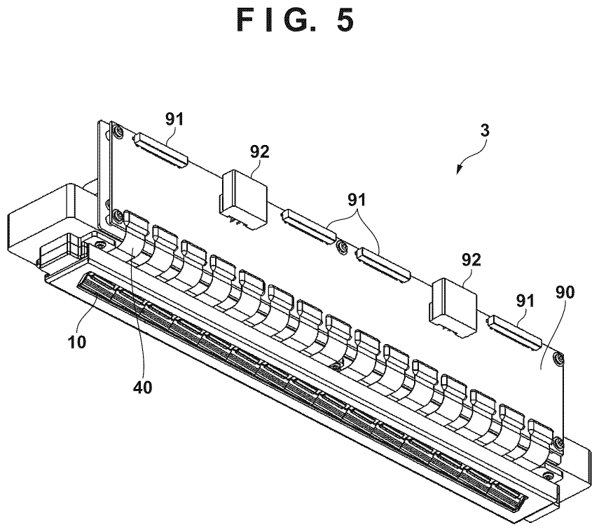

FIG. 5 is a perspective view of the printhead 3 from another viewpoint. As described above, in this embodiment, the printhead 3 is a line head. In addition to the printing element boards 10, the printhead 3 further includes flexible wiring boards 40, a wiring board 90, and signal input terminals 91 and power supply terminals 92 electrically connected via the flexible wiring boards 40 and the wiring board 90. The signal input terminals 91 and the power supply terminals 92 are electrically connected to respective control units of the printing apparatus 1000, and supply discharge driving signals and power required for discharge, respectively, to the printing element boards 10. By consolidating the wirings by the electric circuit in the electric wiring board 90, the number of the signal output terminals 91 and the number of the power supply terminals 92 can be reduced as compared with the number of printing element boards 10. With this configuration, it is possible to reduce the number of electrical connection portions that need to be disconnected when the printhead 3 is attached to the printing apparatus 1000 or when the printhead 3 is replaced.

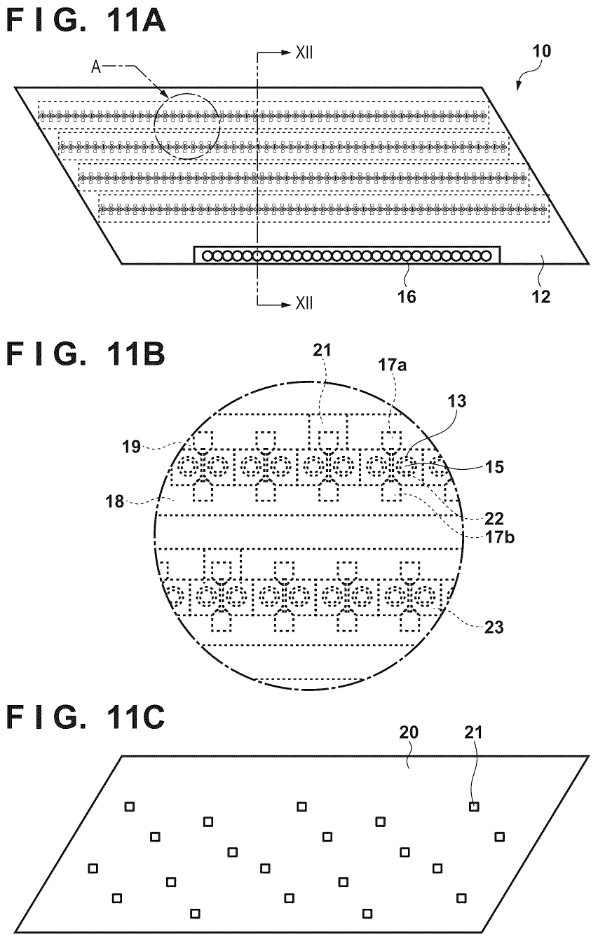

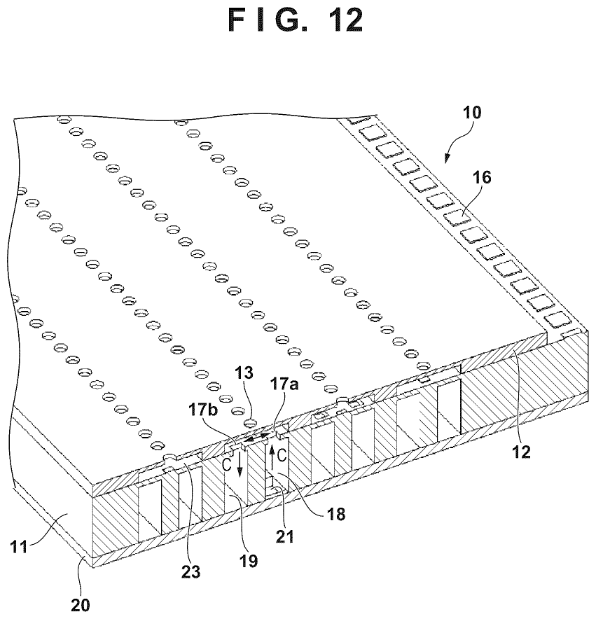

An electrothermal transducer or heater element is provided as a printing element 15 (see FIG. 11B) on the printing element board 10 so as to correspond to each orifice 13. When each electrothermal transducer is energized and driven, the ink is heated and bubbles, and the ink is discharged from the orifice 13 by the foaming energy.

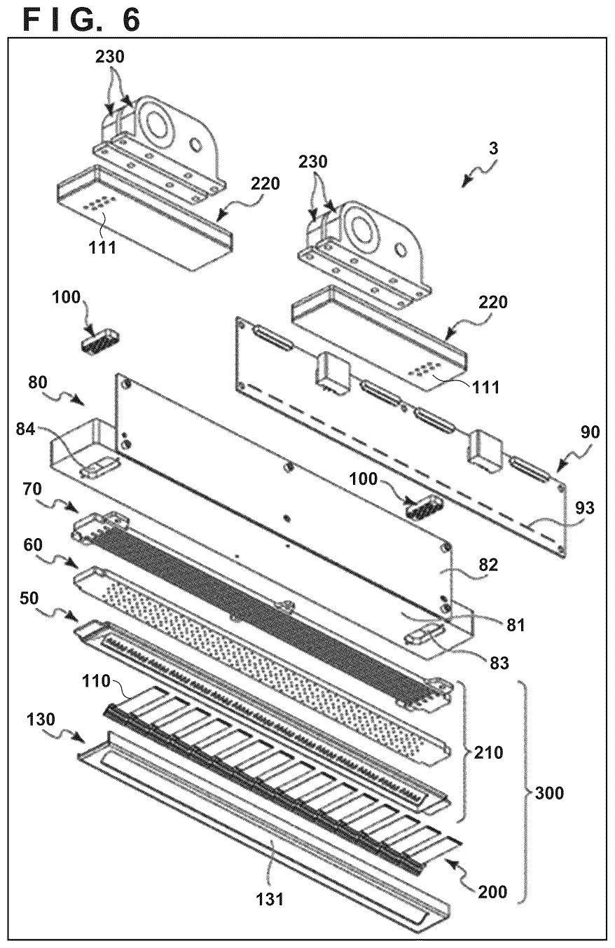

FIG. 6 is an exploded perspective view of the printhead 3. The discharge unit 300, the supply unit 220, and the wiring board 90 are attached to the housing 80. The filter 221 (see FIG. 3) incorporated in the supply unit 220 removes foreign substances in the ink flowing into the supply unit 220 via the connection portion 111. The ink having passed through the filter 221 is supplied to the above-described pressure control unit 230. For each color, the pressure control unit 230 relaxes or attenuates a change in pressure loss in the supply system (the supply system on the upstream side of the printhead 3) of the printing apparatus 1000 caused by a variation in ink flow rate, thereby stabilizing a change in negative pressure on the downstream side (the side of the discharge unit 300). As described above (see FIG. 3), the pressure control unit 230 includes the two known pressure adjustment mechanisms (“H” on the high-pressure side and “L” on the low-pressure side) that generate two negative pressures, respectively.

The housing 80 includes a discharge unit support portion 81 and a wiring board support portion 82, and supports the discharge unit 300 and the wiring board 90 by them while ensuring the rigidity of the printhead 3. The wiring board support portion 82 that supports the wiring board 90 is fixed to the discharge unit support portion 81 by a screw clamp.

The discharge unit support portion 81 that supports the discharge unit 300 ensures accuracy of a relative position with respect to each printing element board 10 by correcting warping or deformation of the discharge unit 300, thereby improving quality of printing. Furthermore, openings 83 and 84 into which joint rubber members 100 are inserted are formed in the discharge unit support portion 81, and the ink supplied by the supply unit 220 is guided to a channel member 210 (to be described later) via the joint rubber members 100. For the discharge unit support portion 81, a metal material such as Steel Use Stainless (SUS) or aluminum or ceramic such as alumina can be used.

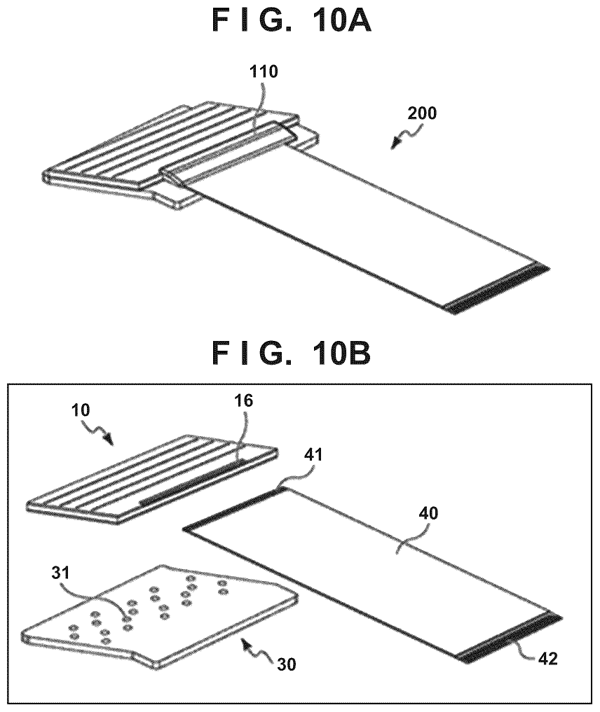

The discharge unit 300 includes a plurality of discharge modules 200 and a channel member 210, and a cover member 130 is attached to the lower surface (the surface on the side of the print medium 2) of the discharge unit 300. The cover member 130 is a frame-like member provided with a long opening 131, as shown in FIG. 6, and a part (the above-described printing element board 10 and a sealing member 110 to be described later (see FIG. 10A)) of each discharge module 200 is exposed from the opening 131.

Note that the frame portion around the opening 131 functions as a cap member for capping the printhead 3 while no printing operation is performed. Therefore, the frame portion may be coated with an adhesive, a sealing material, a filling material, or the like to fill a gap with the printhead 3 to be capped.

As shown in FIG. 6, the channel member 210 is formed by stacking a plurality of (in this example, three) plate materials 50, 60, and 70 in each of which grooves and/or openings are formed, and can distribute, to each discharge module 200, the ink supplied from the supply unit 220. In addition, the channel member 210 can return the ink having passed through the discharge module 200 to the supply unit 220. The channel member 210 is fixed to the discharge unit support portion 81 by screwing so as to suppress warping or deformation.

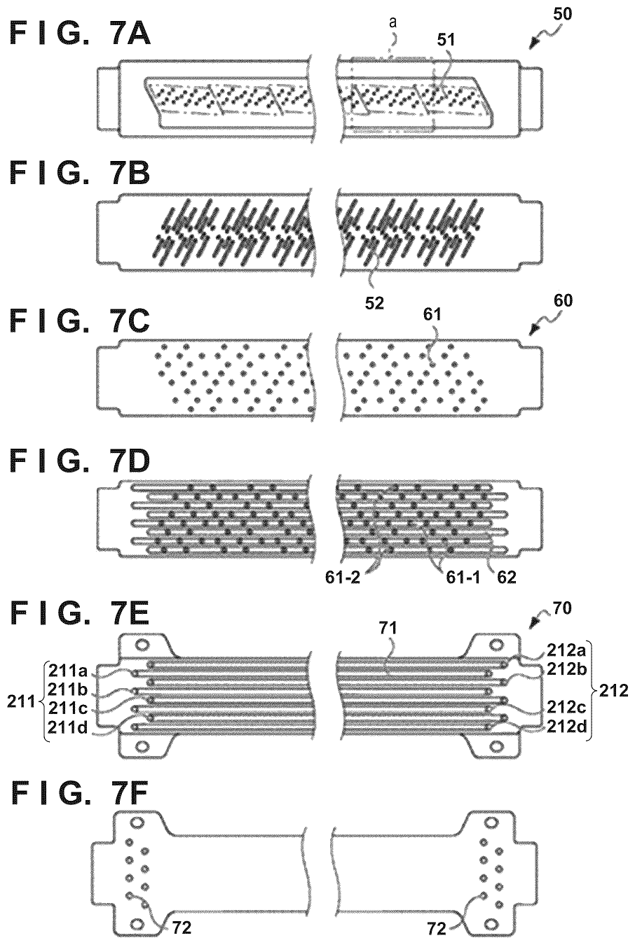

FIGS. 7A to 7F are schematic views showing an example of the configuration of the plate materials 50, 60, and 70 forming the channel member 210. FIG. 7A shows an example of the configuration of the upper surface (the surface on the side of the discharge module 200) of the plate material 50, and FIG. 7B shows an example of the configuration of the lower surface (the surface on the side of the discharge unit support portion 81) of the plate material 50. FIG. 7C shows an example of the configuration of the upper surface of the plate material 60, and FIG. 7D shows an example of the configuration of the lower surface of the plate material 60. FIG. 7E shows an example of the configuration of the upper surface of the plate material 70, and FIG. 7F shows an example of the configuration of the lower surface of the plate material 70.

In the plate material 50, communication ports 51 and individual channel grooves 52 are formed. In the plate material 60, communication ports 61 (communication ports 61-1 and 61-2) and common channel grooves 62 are formed. In the plate material 70, common supply channels 211 (common supply channels 211a, 211b, 211c, and 211d), common recovery channels 212 (common recovery channels 212a, 212b, 212c, and 212d), common channel grooves 71, and communication ports 72 are formed. Note that in FIGS. 7A to 7F, it is distinctly indicated that the communication ports 61-1 communicate with the common supply channels 211 and the communication ports 61-2 communicate with the common recovery channels 212.

These plate materials 50, 60, and 70 are stacked to abut against each other, thereby forming the ink channel of the channel member 210. For example, the plate materials 50 and 60 abut against each other to form a part of the ink channel of the channel member 210 (see FIGS. 7B and 7C). Similarly, the plate materials 60 and 70 abut against each other to form another part of the ink channel of the channel member 210 (see FIGS. 7D and 7E).

With this configuration, common channels (the common supply channels 211a, 211b, 211c, and 211d and the common recovery channels 212a, 212b, 212c, and 212d) extending in the longitudinal direction from the common channel grooves 62 and 71 are formed for respective colors. For example, the common supply channels 211a, 211b, 211c, and 211d and the common recovery channels 212a, 212b, 212c, and 212d are extended in the longitudinal direction of the printhead 3 to correspond to the four ink colors, respectively. As an example, ink of a given color supplied to the discharge module 200 through the common supply channel 211a is recovered through the common recovery channel 212a.

More specifically, the communication ports 72 (see FIG. 7F) of the plate material 70 communicate with holes formed in the joint rubber member 100, and communicate with the supply unit 220 (see FIG. 6). These communication ports 72 each communicate with one end of the individual channel groove 52 of the plate material 50 by the communication port 61 provided in the lower surface of the common channel groove 62 of the plate material 60, and also communicate with each of the plurality of discharge modules 200 via the communication port 51 at the other end. The individual channel grooves 52 can form the ink channel in the central portion of the channel member 210 (see FIG. 7B).

The plate materials 50, 60, and 70 are preferably made of a material having corrosion resistance against the ink and a low expansion coefficient. Examples of the material are a resin material or a composite material containing, as the base material, alumina, liquid crystal polymer (LCP), polyphenylene sulfide (PPS), polysulfone (PSF), or the like and added with an inorganic filler such as silica fine particles or fiber. The channel member 210 is formed by stacking the plate materials 50, 60, and 70 by welding or adhesion.

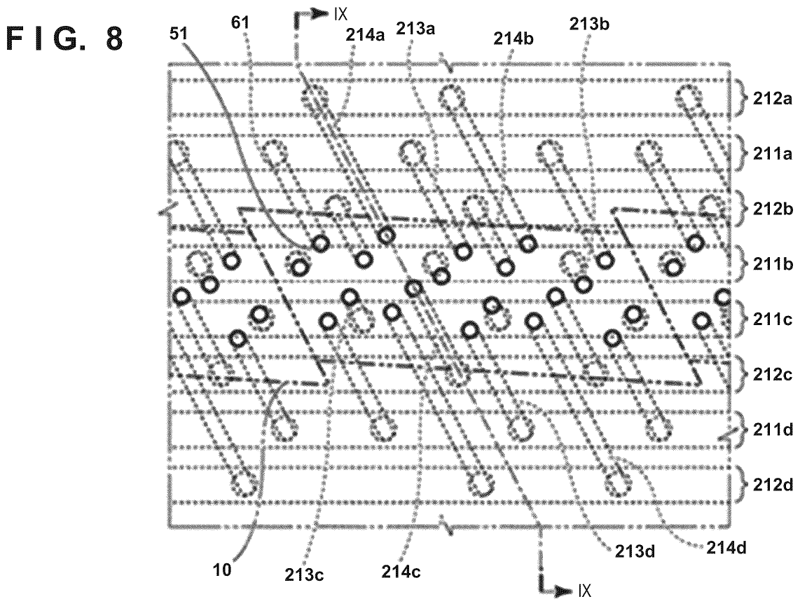

FIG. 8 is an enlarged schematic view of a portion a of the channel member 210 formed by stacking the above-described plate materials 50, 60, and 70 (see FIG. 7A). As shown in FIG. 8, the common supply channels 211 and the common recovery channels 212 are alternately arranged in the longitudinal direction.

The plurality of individual supply channels 213 (213a, 213b, 213c, or 213d) formed by the individual channel grooves 52 are connected to each common supply channel 211 (211a, 211b, 211c, or 211d) via the communication ports 61. In addition, the plurality of individual recovery channels 214 (214a, 214b, 214c, or 214d) formed by the individual channel grooves 52 are connected to each common recovery channel 212 (212a, 212b, 212c, or 212d) via the communication ports 61. With this channel configuration, it is possible to guide the ink to the central portion of the channel member 210 from the common supply channels 211 through the individual supply channels 213 and supply the ink to each printing element board 10, and to recover the ink from each printing element board 10 to the common recovery channels 212 through the individual recovery channels 214.

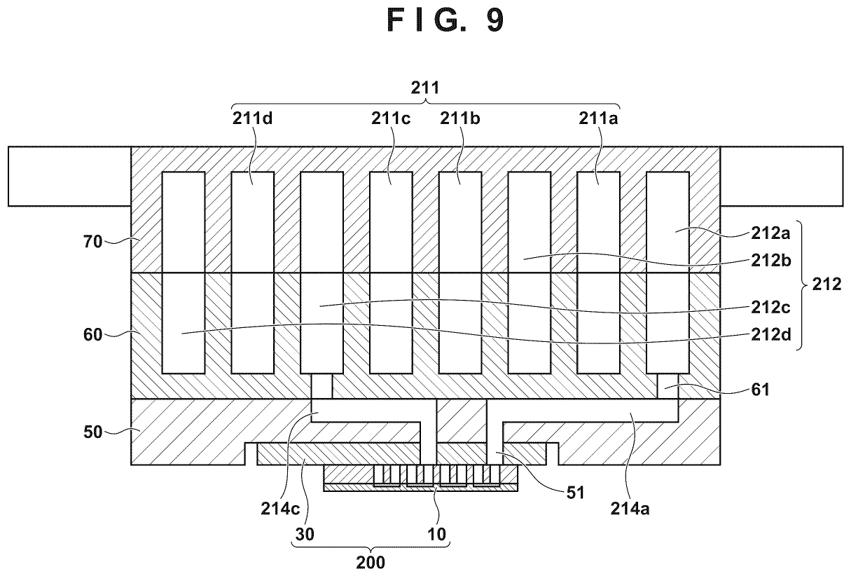

FIG. 9 is a schematic sectional view taken along a cut line IX-IX in FIG. 8. The individual recovery channels 214a and 214c communicate with the discharge modules 200 via the communication ports 51, respectively (the same applies to the individual supply channels 213 and the remaining individual recovery channels 214).

FIG. 10A is a perspective view showing an example of the configuration of the single discharge module 200, and FIG. 10B is an exploded perspective view of it. In addition to the printing element board 10, the discharge module 200 includes a support member 30 and the sealing member 110. In the support member 30, communication ports 31 through which the ink passes are formed.

In the support member 30 and the printing element board 10, a channel for guiding, to the printing element 15 (see FIG. 11B), the ink flowing from the channel member 210 and a channel for recovering, to the channel member 210, a part or all of the ink supplied to the printing element 15 are formed.

The common supply channel 211 corresponding to each ink color is connected to the pressure control unit 230 (high-pressure side) via the supply unit 220, and the common recovery channel 212 is connected to the pressure control unit 230 (low-pressure side) via the supply unit 220. The pressure control unit 230 generates a pressure difference (differential pressure) between the common supply channel 211 and the common recovery channel 212. Therefore, as shown in FIGS. 8 and 9, in the printhead 3, an ink channel is formed so that the ink flows through the common supply channel 211, the individual supply channel 213, the printing element board 10, the individual recovery channel 214, and the common recovery channel 212 in this order.

The discharge module 200 is obtained by adhering the printing element board 10 and the flexible wiring board 40 onto the support member 30, electrically connecting them, and covering and sealing the connection portion by the sealing member 110. The electrical connection between the printing element board 10 and the flexible wiring board 40 can be implemented by connecting a terminal 16 of the printing element board 10 and a terminal 41 of the flexible wiring board 40 by wire bonding. Note that a terminal 42 of the flexible wiring board 40 on the opposite side of the connection side of the printing element board 10 is electrically connected to a connection terminal 93 of the wiring board 90 (see FIG. 6).

The support member 30 is configured to make the printing element board 10 and the channel member 210 communicate with each other while supporting the printing element board 10. Thus, the support member 30 is preferably made of a material that can implement high flatness and can appropriately bond to the printing element board 10, and examples of the material are alumina and a resin material.

### (Structure of Printing Element Board)

FIG. 11A is a plan view of the upper surface (the surface on which the orifices 13 are formed) of the printing element board 10, and FIG. 11B is an enlarged schematic view of a portion A shown in FIG. 11A. FIG. 11C is a plan view of the lower surface (the surface opposite to that shown in FIG. 11A) of the printing element board 10. The printing element board 10 includes an orifice forming member 12 and a cover plate 20. The orifice forming member 12 is located on the upper surface side, and the cover plate 20 is located on the lower surface side.

In the orifice forming member 12, a plurality of (in this example, four) orifice arrays respectively corresponding to the plurality of ink colors are formed, and each orifice array is formed by arraying the plurality of orifices 13 in one direction. In the following description, the array direction (the extension direction of the orifice array) of the orifices 13 can be expressed as an orifice array direction.

As shown in FIG. 11B, on one side of each orifice array, a supply path 18 that communicates with the orifice 13 via a supply port 17a extends along the orifice array. Similarly, on the other side of each orifice array, a recovery path 19 that communicates with the orifice 13 via a recovery port 17b extends along the orifice array.

The printing element 15 is provided at a position corresponding to each orifice 13 in the pressure chamber 23 partitioned by partitions 22. The printing element 15 is electrically connected to the terminal 16 (see FIG. 10B), and is driven based on a driving signal input via the wiring board 90 (see FIG. 6) and the flexible wiring board 40. In accordance with this, the ink is discharged from the corresponding orifice 13.

As shown in FIG. 11C, in the cover plate 20, a plurality of openings 21 that communicate with the supply path 18 and the recovery path 19 are formed. Each opening 21 communicates with the communication port 51 (see FIG. 7A). In this embodiment, assume that three openings 21 are formed for one supply path 18 and two openings 21 are formed for one recovery path 19.

For the cover plate 20, a material that has corrosion resistance against the ink and can readily form the shape and position of the opening 21 with high accuracy is preferably used. Examples of the material are silicon and a photosensitive resin material that can form the opening 21 by a photolithography process. The cover plate 20 preferably has a thin shape (sheet-like or film-like shape) to convert the pitch of the ink channel by the opening 21 and reduce a pressure loss at this time.

FIG. 12 is a sectional perspective view taken along a cut line XII-XII in FIG. 11A. On the printing element board 10, a base 11 typically made of silicon is arranged between the orifice forming member 12 and the cover plate 20. The printing element 15 is formed on the upper surface (the surface on the side of the orifice forming member 12) of the base 11, and the supply path 18 and the recovery path 19 are formed on the lower surface (the surface on the side of the cover plate 20) of the base 11. The cover plate 20 is bonded to the base 11 to function as a cover that seals the supply path 18 and the recovery path 19 or the base 11 and the cover plate 20 are bonded to form the supply path 18 and the recovery path 19.

The supply path 18 and the recovery path 19 are respectively connected to the common supply channel 211 and the common recovery channel 212 of the channel member 210, and a pressure difference is generated between the paths by the pressure control unit 230. At the time of executing printing, regardless of discharge or non-discharge of the ink from the orifice 13, the ink in the supply path 18 flows to the recovery path 19 via the supply port 17a, the pressure chamber 23, and the recovery port 17b due to the pressure difference, as indicated by an arrow C, and is recovered. After that, the ink recovered by the recovery path 19 passes through the opening 21 of the cover plate 20 and the communication port 31 of the support member 30, and also sequentially passes through the communication port 51, the individual recovery channel 214, and the common recovery channel 212 in the channel member 210 (see FIG. 9).

Summarizing ink circulation, in the printhead 3, the ink flows from the connection portion 111 into the supply unit 220. The ink sequentially passes through the joint rubber member 100, the communication port 72 and the common channel groove 71 of the plate material 70, the common channel groove 62 and the communication port 61 of the plate material 60, and the individual channel groove 52 and the communication port 51 of the plate material 50 (see FIGS. 6 to 8). After that, the ink sequentially passes through the communication port 31 of the support member 30, the opening 21 of the cover plate 20, and the supply path 18 and the supply port 17a of the base 11, and is supplied to the pressure chamber 23 (see FIGS. 9 to 12).

A part/all of the ink supplied to the pressure chamber 23, which has not been discharged from the orifice 13, sequentially passes through the recovery port 17b and the recovery path 19 of the base 11, the opening 21 of the cover plate 20, and the communication port 31 of the support member 30 (see FIGS. 9 to 12). After that, the ink sequentially flows through the communication port 51 and the individual channel groove 52 of the plate material 50, the communication port 61 and the common channel groove 62 of the plate material 60, the common channel groove 71 and the communication port 72 of the plate material 70, and the joint rubber member 100 (see FIGS. 6 to 8). Then, the ink flows out of the supply unit 220 from the connection portion 111, and is thus returned from the printhead 3 to the buffer tank 1003 (see FIG. 3).

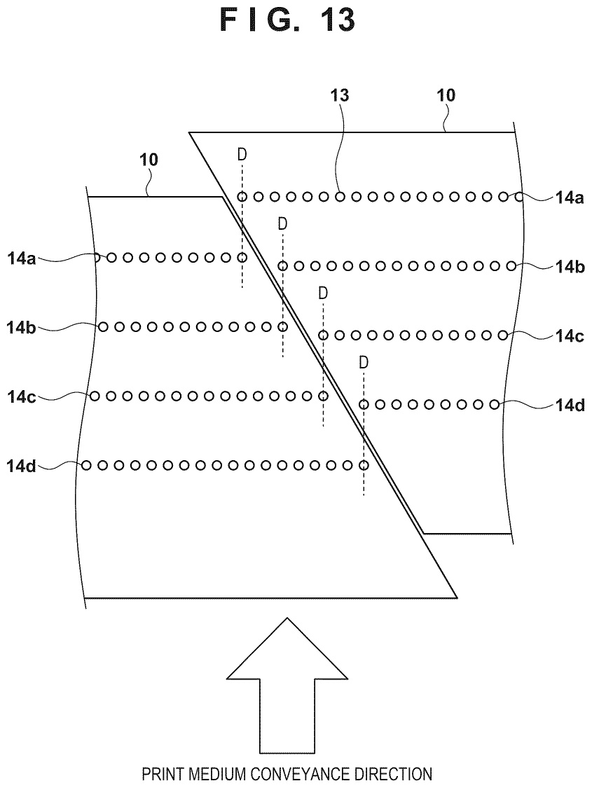

FIG. 13 is an enlarged schematic view of a boundary portion or an adjacent portion between the two adjacent discharge modules 200 (the two adjacent printing element boards 10). In this embodiment, a board having an substantially parallelogram shape is used as the printing element board 10. Orifice arrays 14a to 14d each formed by arraying the plurality of orifices 13 in each printing element board 10 are arranged in a shape inclined at a predetermined angle with respect to the longitudinal direction of the printhead 3. In the boundary portion, the orifice arrays 14a to 14d are arranged so that at least one orifice 13 overlaps in the conveyance direction of the print medium 2. In this example, as shown in FIG. 13, the two orifices 13 on a line D overlap each other.

In this arrangement form, even in a case where the position deviation of the printing element board 10 occurs, it can be complemented by the overlapping orifices 13, thereby suppressing black streaks and a highlight detail loss in a printed image. This is not limited to the above-described arrangement form of the plurality of printing element boards 10 and the same applies to other arrangement forms. Note that in this embodiment, the printing element board 10 having an substantially parallelogram shape has been exemplified. However, the printing element board 10 may have another shape such as a rectangular shape or a trapezoidal shape. In this case as well, the orifice arrays 14a to 14d are preferably arranged so that the orifices 13 overlap each other.

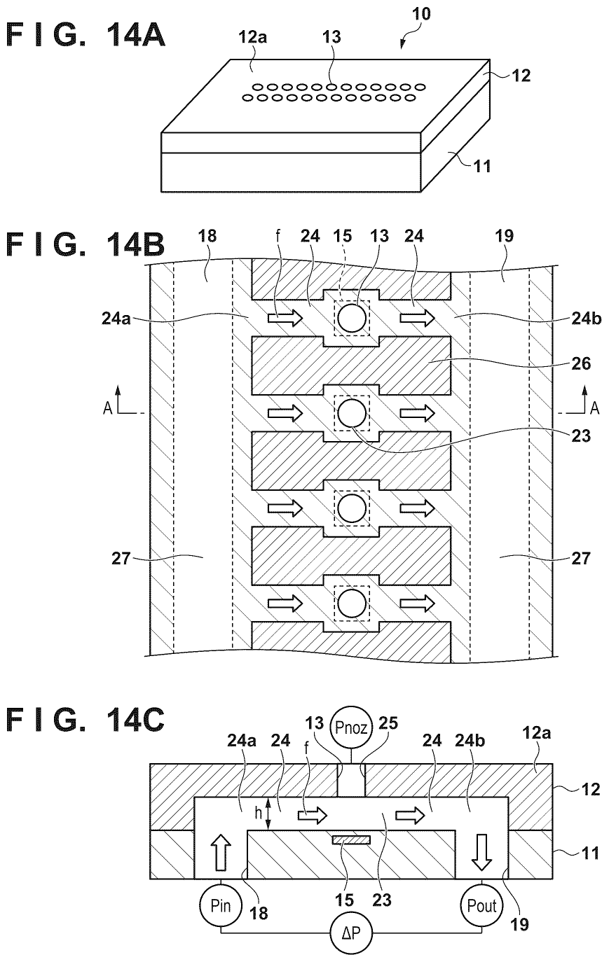

FIG. 14A is a perspective view of the printing element board 10. FIG. 14B is a schematic plan view showing the ink channel in the printing element board 10. FIG. 14C is a schematic sectional view taken along a cut line A-A in FIG. 14B. As described above, the printing elements 15 are provided on the base 11 and the orifices 13 are formed in the orifice forming member 12 (see FIG. 12). In FIGS. 14A and 14C, the surface of the orifice forming member 12 on which the orifices 13 are formed (that is, the surface facing the print medium 2) is illustrated as an orifice forming surface (orifice surface) 12a.

The plurality of orifices 13 are arrayed in one direction, and an ink channel 24 is formed between the base 11 and the orifice forming member 12 to face the printing element 15 and the orifice 13 (see FIGS. 14B and 14C). The adjacent ink channels 24 are partitioned by a wall 26. A space of the ink channel 24, where the printing element 15 and the orifice 13 are provided, corresponds to the pressure chamber 23.

Note that a height h of the ink channel 24 is set based on the refill characteristic and the circulation characteristic of the ink, and can be set within the range of 3 to 25 μm in the case of the printhead 3 with a high density equivalent to 600 dpi or higher.

The supply path 18 and the recovery path 19 are provided to extend through the base 11. The supply path 18 is connected to an inlet end 24a of the ink channel 24, and can supply the ink to the ink channel 24. The recovery path 19 is connected to an outlet end 24b of the ink channel 24, and can recover, from the ink channel 24, the ink that has not discharged from the orifice 13. The printing element 15 and the orifice 13 are preferably formed at a position substantially equidistant from the inlet end 24a and the outlet end 24b in the ink channel 24. A pressure difference ΔP generated between an inlet pressure Pin of the supply path 18 and an outlet pressure Pout of the recovery path 19 is set so that the inlet pressure Pin is higher than the outlet pressure Pout. This generates a circulation flow f so that the ink is supplied from the supply path 18 onto the printing element 15 through the ink channel 24 and flows to the recovery path 19 through the ink channel 24. Note that the inlet pressure Pin and the outlet pressure Pout may be positive or negative.

### (Quality of Ink in Circulation Channel)

The ink in the circulation channel may evaporate by, for example, contacting air in the vicinity of the orifice 13 to increase the viscosity, and thus the ink concentration may become high. The stay of the thickened ink in the vicinity of the orifice 13 can be suppressed by increasing the flow rate (circulation flow rate) of the circulation flow f. On the other hand, the thickened ink generated in the circulation channel flows from the ink channel 24 to the common recovery channel 212 through the recovery path 19 via the outlet end 24b along the circulation flow f, and is then recovered by the buffer tank 1003.

Such thickened ink can be discharged from the orifice 13 and ejected out of the circulation channel. However, if the amount of ink discharged to the print medium 2 (the amount of ink discharged from the orifice 13) is small, the thickened ink returns to the buffer tank 1003 through the recovery path 19, and thus the quality of the ink in the circulation channel degrades. As an example, if the viscosity of the ink is higher than an allowable value (for example, 8 cp), it is difficult to appropriately discharge the ink from the orifice 13. Therefore, this may cause non-discharge, and degrade the quality of printing.

To cope with this, based on the degree of quality degradation of the ink in the circulation channel, the ink is discharged from the orifice 13 and ejected out of the circulation channel by recovery processing such as preliminary discharge or suction processing, thereby recovering the quality of the ink. Therefore, a technique of accurately specifying the quality of the ink in the circulation channel or the degree of quality degradation (for example, the degree of increase in ink concentration, the degree of ink evaporation, the degree of thickening of the ink, and the like) is generally required.

When circulating the ink, the circulation flow rate can be controlled by adjusting the driving force of the pump 1002 (in this embodiment, the duty ratio of the driving signal of the diaphragm pump). The circulation flow rate is continuously detected during ink circulation, and can be measured by the flow rate sensor 1009b (see FIG. 3).

When specifying the quality of the ink, the driving force of the pump 1002 can be fixed to a predetermined driving force, and in this embodiment, the duty ratio of the driving signal can be fixed to a predetermined duty ratio. The driving force of the pump 1002 is preferably set higher than a standard driving force at the time of executing printing (for example, a driving force between a driving force in the case of non-discharge and a driving force in the case of full discharge) to increase the circulation flow rate. This can accurately measure the circulation flow rate by the flow rate sensor 1009b, and thus it is possible to accurately specify the quality of the ink, details of which will be described later.

In addition, the liquid amount sensor 1009a may detect the amount of ink in the buffer tank 1003 and/or the temperature sensor 1009c may detect the temperature of the ink in the circulation channel.

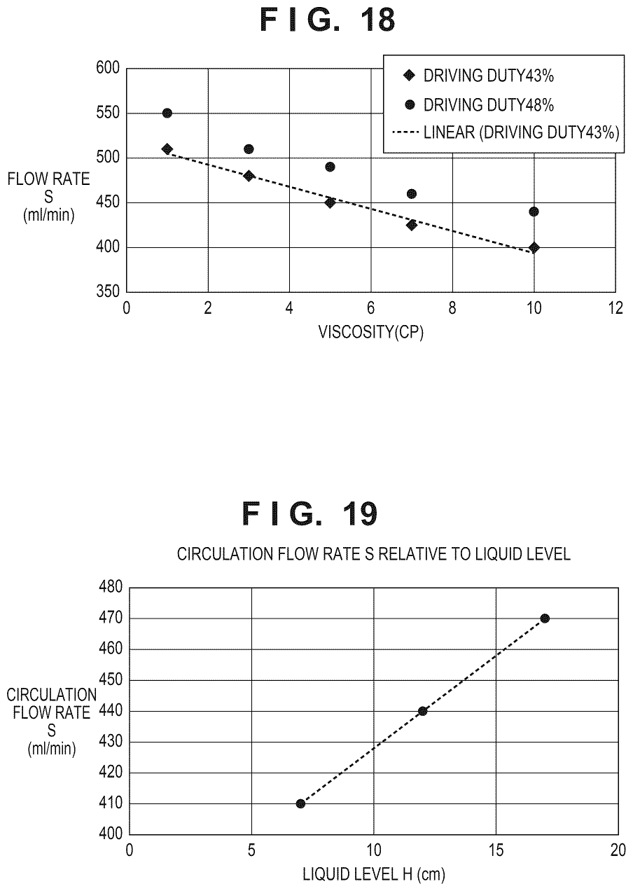

FIG. 18 shows the relationship between the circulation flow rate (a circulation flow rate S in units of [ml/min]) at the given driving force of the pump 1002 and the ink viscosity (an ink viscosity n in units of [cp]). FIG. 18 shows a case where the duty ratio (driving duty) of the driving signal of the diaphragm pump as the driving force of the pump 1002 is 43% and 48%. From FIG. 18, equation (1) below is obtained.

$$S = - 11.4 * η + 514 \qquad ( 1 )$$

FIG. 19 shows the relationship between the circulation flow rate S and the liquid level (a liquid level H in units of [cm]) in the buffer tank 1003 in a case where the liquid amount sensor 1009a detects the amount of ink in the buffer tank 1003. If the liquid level H increases, the circulation flow rate S can change due to a pressure loss occurring in the circulation system including the pump 1002. From FIG. 19, equation (2) below is obtained.

$$S = 6 * H + 368 \qquad ( 2 )$$

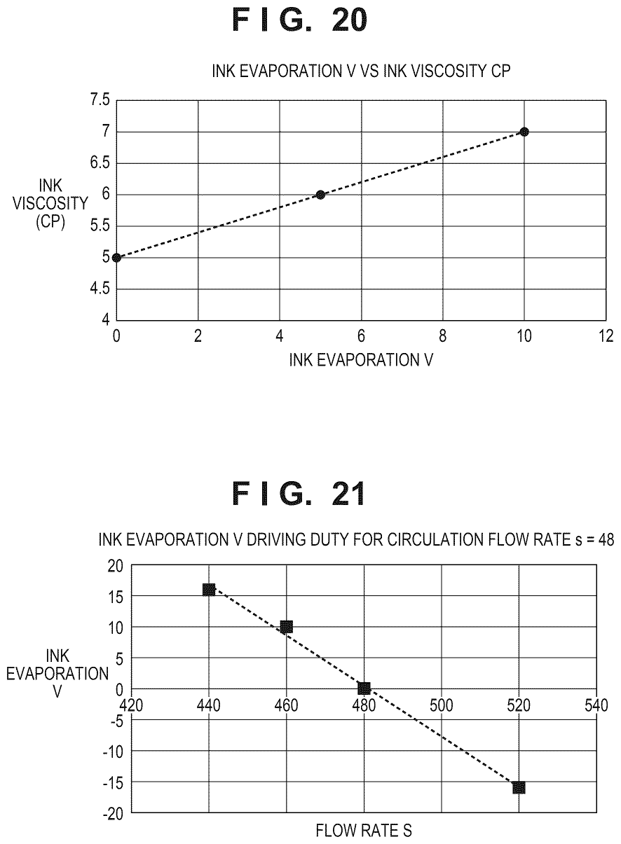

FIG. 20 shows the relationship between the degree of ink evaporation (a degree V of ink evaporation in units of [%]) and the ink viscosity n at a temperature of 25° C. In this example, the degree V of ink evaporation represents the degree of degradation caused by evaporation of water with respect to the ink (unused ink) in the main tank 1006. Since, for example, water does not evaporate with respect to the unused ink (in other words, water evaporates by 0%), V=0 is set. If water evaporates by 10% from the unused ink, V=10 is set.

Note that the ink concentration is the amount of an ink component (for example, a color material such as pigment) contained in water per unit volume, and can be calculated based on the degree V of ink evaporation. When Nref represent the concentration of an unused ink component, an ink concentration N can be given using the degree V of ink evaporation by:

$$N = 100 / ( 100 - V ) * Nref$$

From FIG. 20, equation (3a) below is obtained.

$$η = 0.2 * V + 5 \qquad ( 3 a )$$

That is, equation (3b) below is obtained.

$$V = 5 * η - 25 \qquad ( 3 b )$$

Thus, at any timing, equation (4) below is obtained.

$$V = - 0.439 * S + 2.63 * H + 173 \qquad ( 4 )$$

In a case where the amount of ink in the buffer tank 1003 is maintained constant (a case where the buffer tank 1003 is replenished with the ink by the pump 1001 from the main tank 1006 by the amount of consumed ink discharged from the orifice 13), the liquid level H is a fixed value. FIG. 21 shows the relationship between the degree V of ink evaporation and the circulation flow rate S based on equation (4) above.

As described above, the circulation flow rate S and the ink viscosity n are related in a form approximating a linear function. In a case where the temperature of ink is constant, the ink viscosity n and the degree V of ink evaporation are related in a form approximating a linear function. Furthermore, in a case where the liquid level H is constant, the circulation flow rate S and the degree V of ink evaporation are related in a form approximating a linear function. Therefore, according to this embodiment, it is possible to specify the quality of the ink based on the circulation flow rate S measured by the flow rate sensor 1009b while fixing the driving force of the pump 1001.

In the above description, the liquid level H has been mentioned as an example of the amount of ink in the buffer tank 1003 detected by the liquid amount sensor 1009a, but a plurality of methods of detecting the liquid level H are considered.

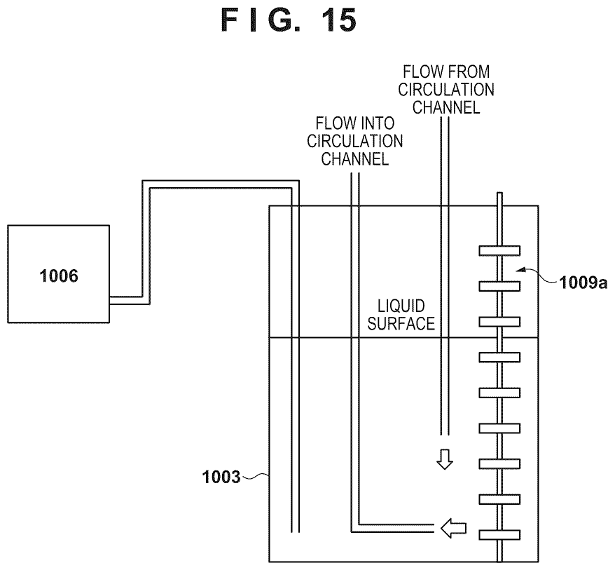

As exemplified in FIG. 15, a plurality of sensors each capable of detecting the presence/absence of ink may be arranged as the liquid amount sensors 1009a at a plurality of heights in the buffer tank 1003, respectively. By increasing the number of sensors, it is possible to accurately detect the liquid level H.

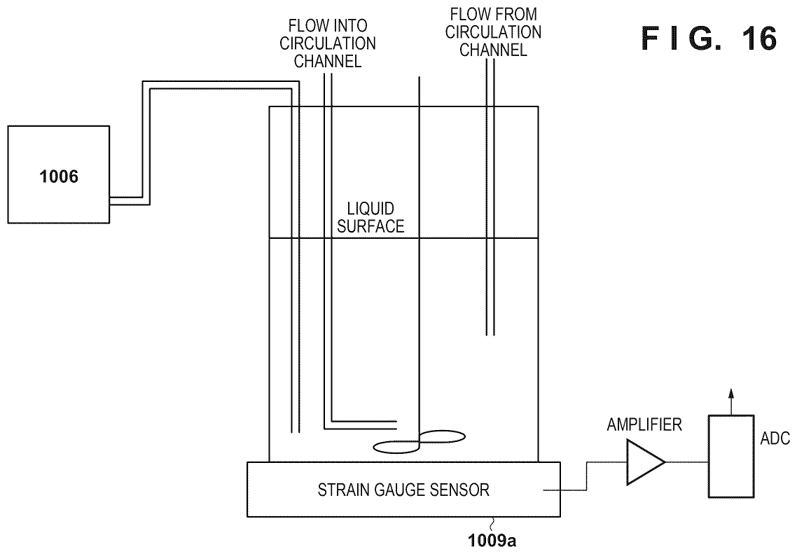

As exemplified in FIG. 16, a strain gauge capable of detecting strain caused by a weight based on the buffer tank 1003 and the amount of ink in the buffer tank 1003 may be arranged as the liquid amount sensor 1009a. Based on the amount of strain, the liquid level H can continuously be detected.

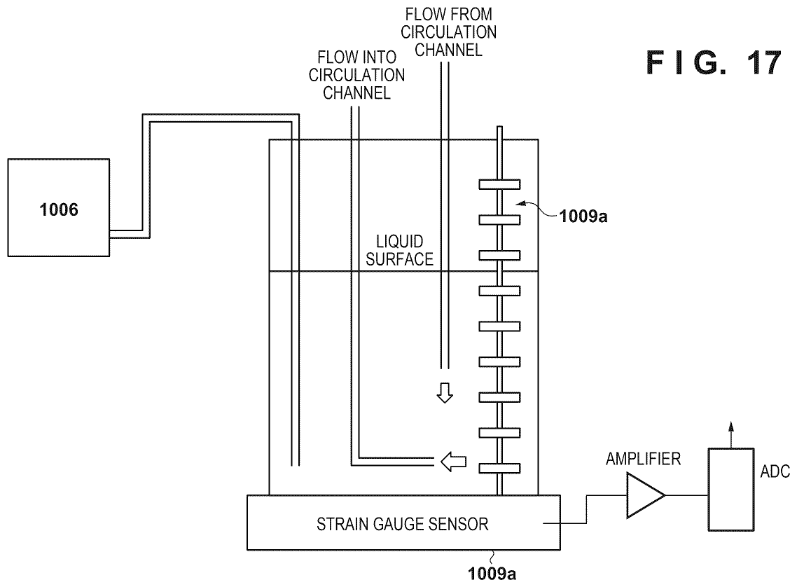

As exemplified in FIG. 17, the configuration shown in FIG. 15 and the configuration shown in FIG. 16 may be combined. With this configuration, the liquid level H can accurately and continuously be detected.

Note that in a case where the amount of ink in the buffer tank 1003 and the weight can accurately be detected, it is possible to specify the specific gravity of the ink. Therefore, it is possible to calculate the quality (ink concentration N or the like) of the ink in the buffer tank 1003 as the quality of the ink in the circulation channel.

### (Required Time and Timing)

The quality of the ink is preferably specified while execution of printing is suppressed (while printing is not executed), and is particularly preferably specified before execution of printing and after the ink is sufficiently circulated. At this time, since the driving force of the pump 1002 is fixed to a predetermined driving force and the temperature of the ink is substantially constant, it is possible to accurately specify the quality of the ink.

The quality of the ink can be specified at, for example, initial setting of the printing apparatus 1000. After supplying the ink from the main tank 1006 to the buffer tank 1003 and filling the circulation channel with the ink, the ink is circulated until the temperature of the ink in the circulation channel becomes stable (substantially constant), and the degree V of ink evaporation is set to V=0. Based on the relationship between the circulation flow rate S and the ink viscosity n, which corresponds to the driving force of the pump 1002 (see FIG. 18) and the relationship between the degree V of ink evaporation and the ink viscosity n (see FIG. 20), the coefficients of equation (4) above can be corrected. By this method, it is possible to specify the quality of the unused ink so as to cope with manufacturing variations and the like.

In a case where it is configured to maintain the temperature of the ink in the circulation channel at a desired temperature (for example, 25° C.) (see FIG. 34), the ink is preferably circulated in advance for a predetermined time so that the temperature of the whole ink is uniform or consistent and the circulation flow rate is stable.

If the ink is not circulated for a relatively long period before execution of printing (for example, the printing apparatus 1000 is OFF for a relatively long period), when the ink is circulated, the time required to stabilize the circulation flow rate may become long. Thus, the ink is preferably circulated until the variation amount of the circulation flow rate measured by the flow rate sensor 1009b falls within a predetermined range. The variation amount can correspond to a time differential.

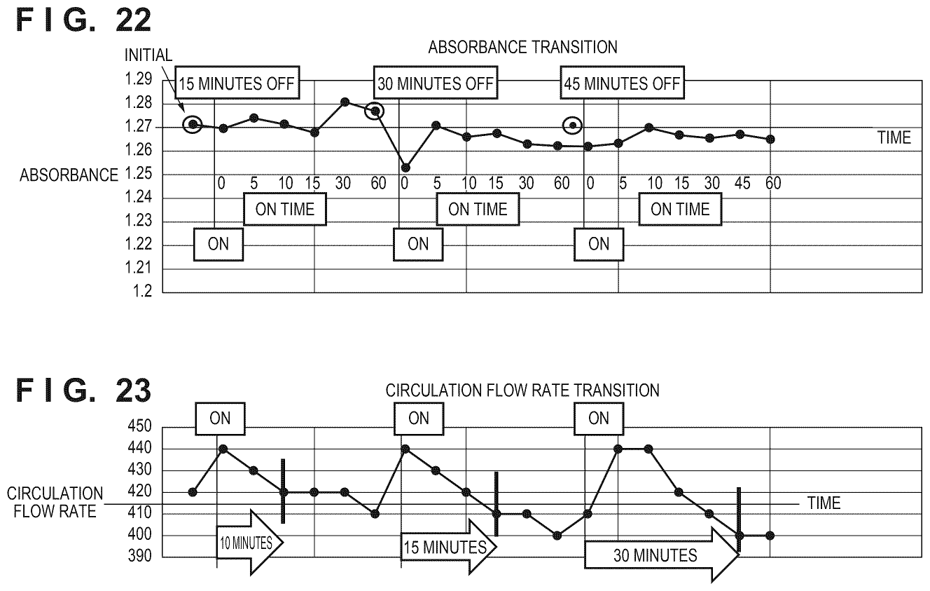

For the sake of easy understanding, FIG. 22 exemplifies, as an example of the ink concentration, white ink whose components readily sediment in a case where the ink is not circulated, and shows the temporal transition of the absorbance of the white ink. Note that the absorbance of the white ink in the vicinity of an ink intake port in the buffer tank 1003 is indicated. In this example, with respect to each of 15 min, 30 min, and 45 min as the time (non-circulation time) during which circulation of the ink is stopped, a state until the absorbance is stabilized over the time (circulation time) during which the ink is circulated after the non-circulation time is shown. As shown in FIG. 22, the absorbance is low immediately after the start of circulation, and returns to the original value over the circulation time.

FIG. 23 shows the measured circulation flow rate with respect to the same timeline as in FIG. 22. If circulation that has been stopped is resumed, the circulation flow rate temporarily increases and then gradually decreases to become stable, as shown in FIG. 23. In addition, as shown in FIG. 23, the time required to stabilize the circulation flow rate is substantially equal to the time required to stabilize the absorbance. Thus, it can be said that the sedimentation state of white ink is dissolved by stabilizing the circulation flow rate.

Note that in FIG. 23, the stabilized circulation flow rate slightly decreases from 420 [ml/min] to 400 [ml/min]. This is because the ink is obtained to measure the absorbance and the liquid level in the buffer tank 1003 thus decreases by about 5 [cm].

As another example, the ink may be circulated over the time corresponding to the non-circulation time. As still another example, the time during which the ink is circulated may be decided by analyzing the form of stabilizing the circulation flow rate based on the measurement result of the flow rate sensor 1009b, and may be decided based on, for example, the time until the variation amount of the circulation flow rate falls within an allowable range.

### (Case Where Main Tank Is Replaced)

The quality of the ink can be specified at the time of replacing the main tank 1006. The ink is supplied from the replaced new main tank 1006 to the buffer tank 1003, and the circulation channel including the printhead 3 is filled with the ink. In this case as well, the quality of the ink is specified in the same procedure.

After replacing the main tank 1006, the quality of the ink remaining in the circulation channel can be different from the quality of the unused ink in the main tank 1006. Therefore, if the ink is supplied from the main tank 1006 to the buffer tank 1003 (the circulation channel is replenished with the ink), the quality of the ink is accordingly specified. In this way, the quality of the ink in the circulation channel can be managed by update.

### (Recovery Processing of Quality of Ink in Circulation Channel)

If the ink concentration N in the circulation channel becomes high, the quality of printing may degrade, for example, an image on the print medium 2 may have an unintended concentration or color. Therefore, if the ink concentration N specified as an element of the quality of the ink is high, a signal for controlling driving of the printhead 3 may be corrected. For example, by adjusting a driving signal (for example, a pulse width) for driving each printing element 15, it is possible to control the discharge amount of ink having the high concentration N and form an image with a desired concentration or color on the print medium 2.

On the other hand, if the ink concentration N is higher than an allowable range, it is possible to discharge and eject the ink having the high concentration from the orifice 13 by recovery processing such as preliminary discharge or suction processing.

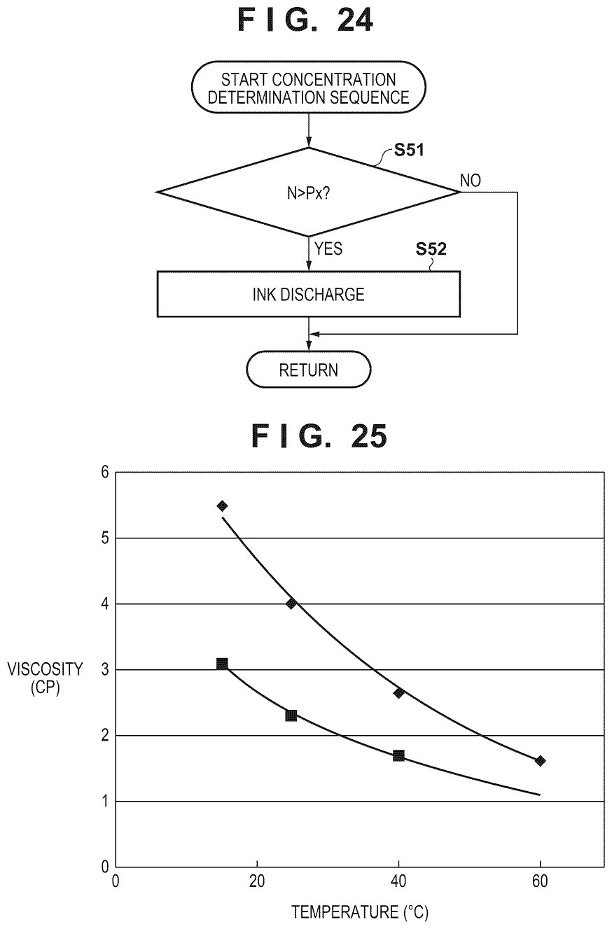

FIG. 24 is a flowchart of control contents performed based on the specified ink concentration N. This flowchart is mainly performed by the controller unit 410 but may be performed by another operation apparatus, as needed (the same applies to other flowcharts to be described later).

In step S51, it is determined whether the ink concentration N is higher than an upper limit value (threshold concentration) Px of the allowable range (N>Px). Assume, for example, that the upper limit value Px is stored in advance in a predetermined memory, as exemplified in table 1.

TABLE 1

| COLOR | Bk | Cy | Ma | Ye |
|---|---|---|---|---|
| Px | 0.089 | 0.067 | 0.067 | 0.067 |

If the ink concentration N is higher than the upper limit value Px, ink discharge processing is performed in step S52. This processing is performed by recovery processing such as preliminary discharge or suction processing. Preliminary discharge is implemented by discharging the ink from each orifice 13 and ejecting the ink to a waste liquid tank (not shown) incorporated in the printing apparatus 1000. The suction processing is implemented by performing negative pressure suction for each orifice 13 by a recovery unit (not shown) incorporated in the printing apparatus 1000. After that, the buffer tank 1003 is replenished with the ink from the main tank 1006 by the pump 1001, and the quality of the ink in the circulation channel is recovered in this manner.

### Summary

According to this embodiment, the quality of the ink in the circulation channel is specified, and the quality of the ink in the circulation channel is recovered by performing recovery processing in accordance with the specifying result, thereby making it possible to appropriately maintain the ink concentration in the circulation channel. The quality of the ink is specified based on the circulation flow rate when fixing the driving force of the pump 1002, and thus the ink viscosity n, the degree V of ink evaporation, and the ink concentration N are accurately specified as indicators of the quality of the ink. Therefore, according to this embodiment, unnecessary recovery processing is not performed.

In a relatively stable environment or the configuration (see FIG. 34) in which the heat exchanger and the chiller set to a predetermined temperature are arranged, the ink temperature is substantially constant (for example, 25° C.). In this case, variations of the ink viscosity η (=η₀*exp (E/kT)) depending on a temperature T of the ink are suppressed.

On the other hand, if the temperature T varies, the ink viscosity η at this time can be equivalently converted into the ink viscosity when the ink temperature is 25° C. (see FIG. 25). Thus, it is possible to refer to FIG. 20 that shows the relationship between the degree V of ink evaporation and the ink viscosity n at the temperature of 25° C., thereby specifying the quality of the ink.

### Second Embodiment

At the time of executing printing, the ink temperature may become locally high in a circulation channel due to an increase in temperature of a printhead 3 or the like, and the temperature of the whole ink channel may not be uniform. The temperature can be different from the temperature detected by a temperature sensor 1009c. The second embodiment is different from the above-described first embodiment in that the quality of ink is specified during execution of printing.

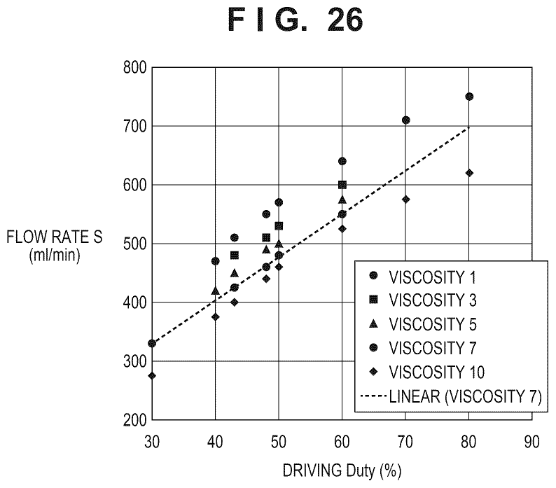

FIG. 26 shows the relationship between a circulation flow rate S and the duty ratio (driving duty) of a driving signal of a diaphragm pump as the driving force of a pump 1002 for each of some ink viscosities n. As shown in FIG. 26, within the range of usable driving duty, the relationship between the circulation flow rate S and the driving duty indicates substantially linear with respect to an arbitrary ink viscosity n.

FIG. 27 is a graph showing the relationship between the driving duty and the ink viscosity n at the given circulation flow rate S (in this example, S=460 [ml/min]). Since the driving duty is controlled so as to maintain the circulation flow rate substantially constant even during execution of printing, it is possible to specify the ink viscosity n based on the driving duty at this time.

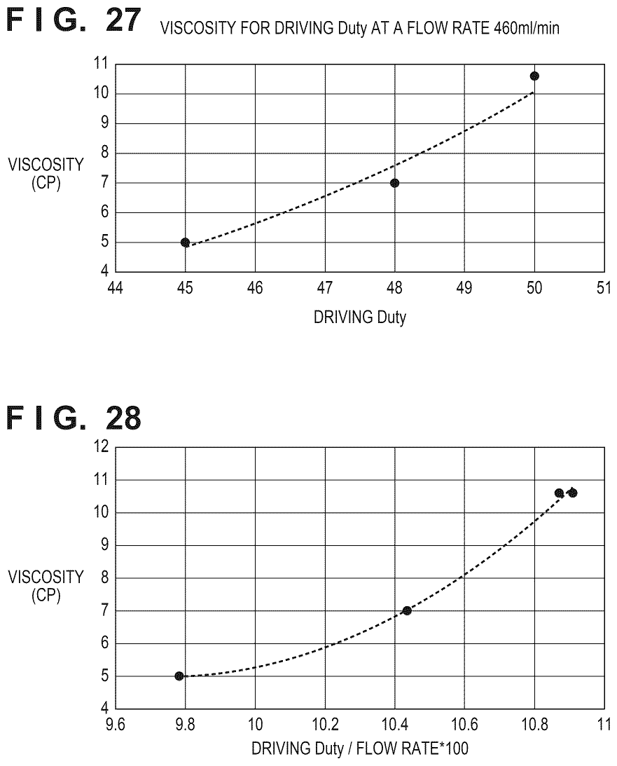

FIG. 28 is a graph showing the relationship between the ink viscosity n and the ratio of the driving duty to the circulation flow rate S. If the circulation flow rate S varies within an allowable range, a specification error of the ink viscosity n caused by the variation of the circulation flow rate S can be suppressed by referring to FIG. 28.

If the temperature of the ink in the circulation channel is specified separately from the thus specified ink viscosity n, it is possible to accurately specify an ink concentration N. On the other hand, as described above, the temperature of the whole ink channel may not be uniform, and the temperature can be different from the temperature detected by the temperature sensor 1009c.

Therefore, in this embodiment, the temperature of the ink in the circulation channel is calculated based on a plurality of temperature detection results. As an example, the detection result of the temperature sensor 1009c may be corrected based on the temperature of the printhead 3 (the detection result of a head temperature sensor that can be provided in the printhead 3) and room temperature (the detection result of an external temperature sensor that can be provided in the housing of a printing apparatus 1000), and determined as the temperature of the ink in the circulation channel. As still another example, the temperature of the ink in the circulation channel may be calculated by weighted addition of the detection result of the temperature sensor 1009c, the temperature of the printhead 3, and room temperature. The calculation method is different depending on the configuration of the printing apparatus 1000, and is thus preferably decided by a predetermined experiment.

### Third Embodiment

The third embodiment will exemplify another method of specifying quality of ink during execution of printing. An outline is to specify quality of ink by calculating an evaporation amount of water from the ink in a circulation channel. In this embodiment, if printing is executed, the quality of the ink is specified based on the evaporation amount of ink, and if printing is not executed, the quality of the ink is specified based on a circulation flow rate by the same procedure as in the above-described first embodiment. That is, there exist two modes for specifying the quality of the ink, and one of the modes is selectively executed based on whether printing is executed or not.

While the above-described degree of ink evaporation (in units of [%]) indicates the percentage of water reduced due to evaporation from the ink in the original state, the evaporation amount indicates the amount of water reduced due to evaporation.

### (Evaporation Amount of Ink in Circulation Channel)

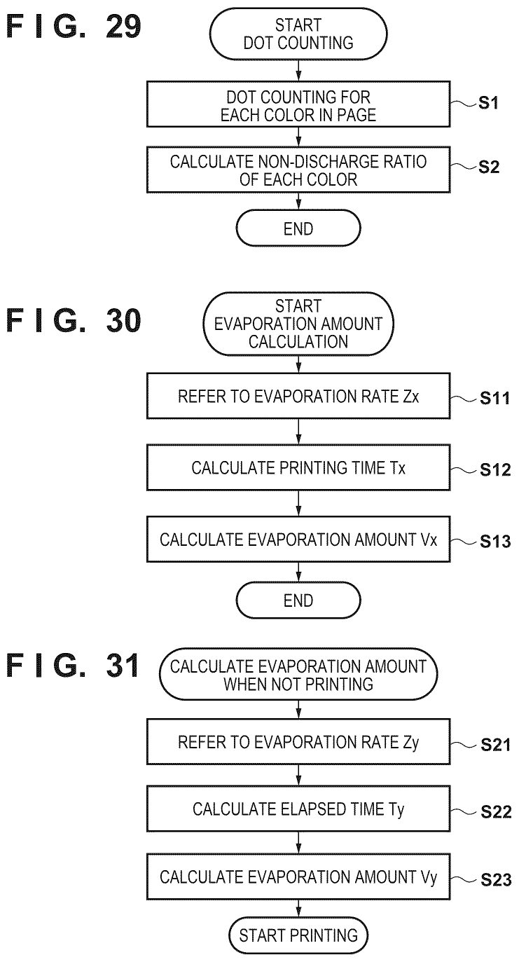

FIG. 29 is a flowchart illustrating contents of operation processing when a printing apparatus 1000 receives a print job (a job for instructing execution of printing). An outline of this flowchart is to calculate or measure, based on image data, the number of ink droplets (the number of ink dots) to be discharged to a print medium 2 (to be referred to as dot counting hereinafter). Assume, for example, that one ink droplet discharged from a corresponding orifice 13 by driving a given printing element 15 is one dot (that is, a dot value obtained by dot counting corresponds to the number of discharges of the ink from the orifice 13). The evaporation amount is calculated based on the dot counting.

In response to the reception of the print job, in step S1, dot counting is performed in a page for each color by analyzing the image data included in the print job. Dot counting is collectively performed for 15 printing element boards 10 arrayed in a longitudinal direction in a printhead 3, but may be performed for each printing element board 10.

In step S2, a non-discharge ratio Hx is calculated for each color. The non-discharge ratio Hx indicates the ratio of the number of non-discharges to the number of discharges in a case of full discharge. For example, a dot value DALL in the case of full discharge and a dot value Dox indicating the actual number of discharges are used to calculate the non-discharge ratio Hx by:

$$Hx = ( {D}_{ALL} - {D}_{ON} ) / {D}_{ALL}$$

FIG. 30 is a flowchart illustrating contents of operation processing for calculating an evaporation amount. Prior to execution of this operation processing, an evaporation amount of water per unit time from one orifice 13 while circulating the ink under a predetermined temperature condition is measured as an evaporation rate Zx (in units of [μg/sec]), as shown in Table 2, and stored in a predetermined memory. In step S11, the evaporation rate Zx corresponding to the temperature of the printhead 3 is referred to.

TABLE 2

| | |
|---|---|
| EVAPORATION | CONTROL TEMPERATURE [° C.] |

| RATE [μg/sec] | <25 | <40 | ≥40 |
|---|---|---|---|
| Zx | 40 | 150 | 420 |

In step S12, a printing time Tx required to print a unit page is calculated. The printing time Tx can be calculated by dividing the length (page length) of the print medium 2 in the conveyance direction by a conveyance speed. After that, in step S13, the evaporation amount Vx is calculated. The evaporation amount Vx is obtained by multiplication of the evaporation rate Zx, the printing time Tx, and the non-discharge ratio Hx by:

$$Vx = Zx * Tx * Hx$$

The above operation processing is repeatedly performed for all pages printed by the print job, thereby calculating the evaporation amount Vx from the printhead 3 during execution of printing.

(Evaporation Amount in Case where Printing is not Executed)

It has been explained that the quality of the ink is specified based on the circulation flow rate in a case where printing is not executed. However, even in a case where printing is not executed, the quality of the ink may be specified based on the evaporation amount. In a case where printing is not executed, since each orifice 13 of the printhead 3 is capped by a cap member, an evaporation rate (an evaporation rate Zy for discrimination in units of [μg/min]) in a case where printing is not executed is lower than the evaporation rate Zx, as shown in Table 3.

TABLE 3

| EVAPORATION | ENVIRONMENTAL TEMPERATURE [° C.] | | |
|---|---|---|---|
| RATE [μg/min] | <15 | <25 | ≥25 |
| Zy | 1 | 2 | 5 |

As shown in FIG. 31, in step S21, the evaporation rate Zy corresponding to the temperature of the printhead 3 is referred to. Then, in step S22, an elapsed time Ty when printing is not executed is calculated. After that, in step S23, an evaporation amount Vy is calculated. The evaporation amount Vy is obtained by multiplication of the evaporation rate Zy and the printing time Ty by:

$$Vy = Zy * Ty$$

In this case, a total evaporation amount VTotal up to now can be calculated by cumulative addition of the evaporation amount Vx while printing is executed and the evaporation amount Vy while printing is not executed.

### (Calculation of Consumed Ink Amount)

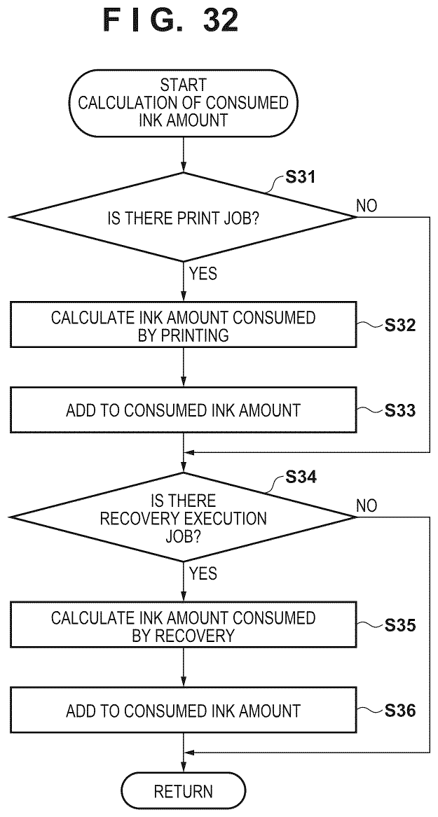

FIG. 32 is a flowchart illustrating contents of operation processing for calculating a consumed ink amount as one of parameters which are referred to in order to specify the ink concentration.

In step S31, the presence/absence of a print job is determined. If the presence of a print job is determined, the process advances to step S32. If the absence of a print job is determined, the process advances to step S34. In step S32, based on the operation result of the above-described dot counting, a printing consumed ink amount along with execution of printing is calculated. In step S33, the printing consumed ink amount is added to a consumed ink amount In.

In step S34, the presence/absence of a recovery execution job for instructing execution of recovery processing is determined. If the presence of a recovery execution job is determined, the process advances to step S35. If the absence of a recovery execution job is determined, this flowchart ends. In step S35, a recovery consumed ink amount along with execution of recovery processing is obtained (the recovery consumed ink amount is stored in advance in the memory). In step S36, the recovery consumed ink amount is added to the consumed ink amount In.

As described above, the consumed ink amount In is cumulatively added every time a print job or a recovery execution job is received, thereby making it possible to specify the amount of ink in the circulation channel.

### (Specification of Ink Concentration)

In this embodiment, based on the result calculated as described above, the ink concentration can be specified as the quality of the ink in the circulation channel, and the specified ink concentration can be updated. Note that as described above, the ink concentration is the amount of an ink component (pigment or the like) contained in water per unit volume.

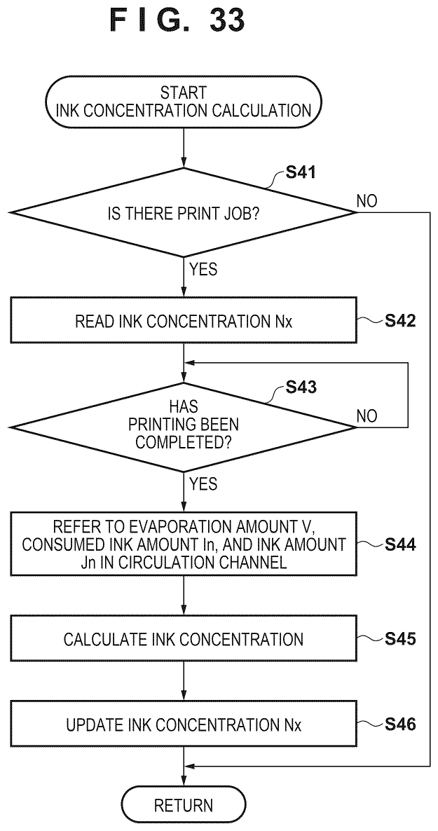

FIG. 33 is a flowchart illustrating contents of operation processing for calculating the ink concentration in the circulation channel. In step S41, the presence/absence of a print job is determined. If the absence of a print job is determined, this flowchart ends. If the presence of a print job is determined, the process advances to step S42. In step S42, a previous ink concentration Nx is read out from the memory.

With respect to the ink concentration Nx, an unused ink concentration Nref as an initial value is preset, as shown in Table 4.

TABLE 4

| COLOR | Bk | Cy | Ma | Ye |
|---|---|---|---|---|
| Nref | 0.08 | 0.06 | 0.06 | 0.06 |

In step S43, it is determined whether printing is complete. Upon completion of printing, the process advances to step S44. In step S44, the evaporation amount Vx, the consumed ink amount In after the completion of printing, and an amount Jn of the ink in the circulation channel shown in Table 5 are referred to.

TABLE 5

| COLOR | Bk | Cy | Ma | Ye |
|---|---|---|---|---|
| Jn [g] | 194 | 188 | 185 | 183 |

In step S45, based on the evaporation amount Vx, the consumed ink amount In, and the amount Jn of the ink in the circulation channel which have been referred to, the ink concentration Nx is updated. For the sake of easy understanding, when Nx represents the ink concentration before update, and Nx′ represents the ink concentration after update.

$${Nx}^{′} = ( Nx * ( Jn - In ) ) / ( Jn - In - Vx )$$

is calculated. Thus, the ink concentration Nx is updated, and stored and retained in the memory in step S46.

According to this embodiment, while printing is executed, the quality of the ink can be specified based on the evaporation amount. After that, similar to the above-described first embodiment, recovery processing is performed based on the specifying result (based on the degree of quality degradation of the ink).

The form of controlling the circulation flow rate by adjusting the duty ratio of the driving signal of the pump has been explained while exemplifying the diaphragm pump as the pump 1002. However, this embodiment is advantageous in a case where the circulation flow rate is controlled by another method.

The form of selectively executing one of the two modes including the mode of specifying the quality of the ink based on the circulation flow rate and the mode of specifying the quality of the ink based on the evaporation amount has been exemplified but these modes may be executed in parallel/simultaneously. These two modes can be executed simultaneously regardless of whether printing is executed.

In this case, out of two results specified in the two modes, one result in which the degree of quality degradation is higher (in the above-described example, the specified ink concentration is higher) may be referred to. This can appropriately maintain the quality of the ink in the circulation channel regardless of specification accuracy of the two modes.

### <<Program>>

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

### <<Others>>

In the embodiments, each element is named using an expression based on its main function. However, each function described in the embodiments may be a sub-function, and is not strictly limited to the expression. The expression can be replaced with another similar expression. In the same vein, an expression “unit or portion” can be replaced with “tool”, “component”, “member”, “structure”, “assembly”, or the like. Alternatively, these may be omitted or added.

In addition, two or more elements selectably exemplified in the embodiments are not strictly limited to the exemplification, and may arbitrarily be combined. For example, each of the two or more elements exemplified may be additionally selected or alternatively selected. As an example, when arbitrarily combining two elements A and B, to indicate one of “only A”, “only B”, and “both A and B”, an expression “A and/or B” may be used, or an expression “at least one of A and B” may be used.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-208882, filed Nov. 29, 2024, which is hereby incorporated by reference herein in its entirety.

What is claimed is:

1. A printing apparatus including a printhead configured to execute printing by discharging ink, a tank configured to store ink to be supplied to the printhead, and a pump arranged in a circulation channel of ink passing through the tank and the printhead, the apparatus further comprising:
a measurement unit configured to measure, as a circulation flow rate, a flow rate of the ink that circulates in the circulation channel by the pump; and
a specifying unit configured to specify quality of the ink in the circulation channel based on the circulation flow rate measured by the measurement unit.

2. The apparatus according to claim 1, wherein
the specifying unit specifies a degree of evaporation of the ink in the circulation channel based on the circulation flow rate measured by the measurement unit.

3. The apparatus according to claim 1, wherein
the specifying unit specifies a viscosity of the ink in the circulation channel based on the circulation flow rate measured by the measurement unit.

4. The apparatus according to claim 1, wherein
the specifying unit specifies the quality of the ink in the circulation channel further based on an amount of ink in the tank.

5. The apparatus according to claim 1, further comprising a temperature detection unit configured to detect a temperature of the ink in the circulation channel,
wherein the specifying unit specifies the quality of the ink in the circulation channel further based on the temperature detected by the temperature detection unit.

6. The apparatus according to claim 1, further comprising a driving control unit configured to control driving of the pump,
wherein the specifying unit specifies the quality of the ink in the circulation channel further based on a driving force of the pump by the driving control unit.

7. The apparatus according to claim 6, wherein
the driving control unit sets the driving force of the pump to a fixed value at the time of circulating the ink in the circulation channel.

8. The apparatus according to claim 6, wherein
the specifying unit specifies the quality of the ink in the circulation channel after circulation of the ink in the circulation channel is started and a variation amount of the circulation flow rate measured by the measurement unit falls within a predetermined range.

9. The apparatus according to claim 6, wherein
the printhead starts the printing after circulation of the ink in the circulation channel is started and a variation amount of the circulation flow rate measured by the measurement unit falls within a predetermined range.

10. The apparatus according to claim 9, wherein
the driving control unit
sets the driving force of the pump to a fixed value at the time of circulating the ink in the circulation channel, and
controls the driving force of the pump based on the circulation flow rate measured by the measurement unit at the time of executing the printing by the printhead.

11. The apparatus according to claim 10, wherein
the pump is arranged in a channel from the printhead to the tank in a circulation direction of the ink in the circulation channel.

12. The apparatus according to claim 6, further comprising a print control unit configured to control driving of the printhead,
wherein the print control unit corrects a signal for controlling driving of the printhead based on the quality of the ink in the circulation channel specified by the specifying unit.

13. The apparatus according to claim 1, further comprising an update unit configured to update the ink in the circulation channel based on a specifying result of the specifying unit.

14. The apparatus according to claim 13, wherein
the update unit updates the ink in the circulation channel by causing the printhead to discharge the ink.

15. The apparatus according to claim 13, wherein
the tank is connected to a main tank configured to store ink, and
the update unit updates the ink in the circulation channel by supplying the ink from the main tank to the tank.

16. The apparatus according to claim 1, further comprising a calculation unit configured to calculate an evaporation amount of ink in the circulation channel,
wherein the specifying unit specifies the quality of the ink in the circulation channel further based on the evaporation amount calculated by the calculation unit.

17. The apparatus according to claim 1, wherein
the specifying unit specifies a sedimentation state of a component of the ink in the tank based on the circulation flow rate measured by the measurement unit.

18. The apparatus according to claim 17, further comprising a decision unit configured to decide, based on the circulation flow rate measured by the measurement unit, a time during which the ink in the circulation channel is circulated.

19. The apparatus according to claim 18, wherein the decision unit decides, based on a variation amount of the circulation flow rate measured by the measurement unit, the time during which the ink in the circulation channel is circulated.

20. The apparatus according to claim 1, wherein
the quality is a concentration.

21. A printing apparatus comprising:
a printhead configured to execute printing by discharging ink;
a tank configured to store ink to be supplied to the printhead;
a pump arranged in a circulation channel of ink passing through the tank and the printhead,
a driving control unit configured to control driving of the pump; and
a specifying unit configured to specify quality of the ink in the circulation channel based on a driving force of the pump by the driving control unit.

22. The apparatus according to claim 21, wherein
the quality includes a concentration and/or a viscosity.

23. A non-transitory computer-readable storage medium, storing a program for causing a computer to function as each unit of a printing apparatus defined in claim 1.
